(19) United States
(12) Patent Application Publication
(10) Pub. No.: US 2004/0015610 A1
(43) Pub. Date: Jan. 22, 2004

(54) Methodology and components for client/server messaging system

(75) Inventor: William Scott Treadwell, Alexandria, VA (US)

Correspondence Address: TIMOTHY J MARTIN, PC, 9250 W 5TH AVENUE, SUITE 200, LAKEWOOD, CO, 80226, US

(73) Assignee: Sytex, Inc.

(21) Appl. No.: 10/200,014

(22) Filed: Jul. 18, 2002

(51) Int. Cl. G06F 15/16

(52) U.S. Cl. 709/246; 709/206

(57) ABSTRACT

A computerized instant messaging (IM) methodology allows secure data transmission between sending and recipient client computer systems each residing on a common network infrastructure. Each computer system has an installed client application program, and the network infrastructure includes a network server having an associated server application program installed thereon. A computer-readable medium is also provided for use as a component of a client computer system that has a graphical user interface including a monitor and at least one data input device, with the client computer system being one of a plurality of computer systems each residing as a respective node on a network infrastructure that includes a network server for interfacing with the client computer systems to enable an exchange of messages therebetween as part of a client/server IM application. A client computer system for use as a component in a client/server messaging application is also provided.

### FIELD OF THE INVENTION

The present invention broadly relates to the field of network computer communications. More particularly, the present invention concerns those communications which take place between computer systems residing as nodes/clients on a private network, such as an organization's LAN or WAN. The present invention is even more specifically directed to systems, components and methodologies for providing secure instant messaging between computer systems.

### BACKGROUND OF THE INVENTION

Since its inception in the 1960's as a packet-switched network enabling the US Department of Defense to interconnect DOD-funded research sites, the internet in recent years has grown exponentially into a robust, global network connecting millions of computers. Because the internet provides fast, inexpensive access to information in revolutionary ways, it has emerged from relative obscurity to international prominence. The internet itself comprises thousands of interconnected computer networks which are able to share information. These individual computer networks may be of a variety of types, such as local-area networks (LANS) and wide-area networks (WANS), to name a few, and may be categorized by various characteristics including topology, communication protocols and network architecture.

While the world wide web can be described as comprising all nodes on the public internet which communicate with one another via standardized protocols, such as the TCP/IP suite and HTTP, the internal web or the “intranet” can be described as comprising all nodes on a private network. These private networks, which are generally based either on TCP/IP protocols or their own proprietary protocols, often belong to organizations and may also assume different types and architectures. Where private networks are concerned, firewalls are generally implemented in both hardware and software to prevent unauthorized users from accessing private networks that are connected to the internet, especially intranets. All messages entering or leaving the internet pass through the firewall, which examines each message and blocks those that do not meet the specific security criteria.

Unfortunately, however, commensurate with the unprecedented access to information and ease of communication afforded by the internet and intranets, has come unprecedented opportunities to infiltrate computer network systems through sniffing or spoofing and gain unauthorized access to sensitive data. Once a network has been successfully infiltrated, a hacker has at his/her disposal the ability, among other things, to manipulate data, make unauthorized use of computer resources or interfere with the intended use of these resources. Infiltration of computer systems can occur in various ways because connected systems almost always have certain vulnerabilities. Accordingly, as long as companies use computer networks for sharing and exchanging data they run the risk that outsiders will breech security and reek havoc with computer networks. As a result of these inherent vulnerabilities, the field of intrusion detection has appreciated rapid growth in recent years.

This is particularly true when individuals transmit messages over the network infrastructure. The transmission of messages over one or more networks can take place in a variety of manners. These messages can be notes entered from an input device, such as a keyboard, or an electronic file stored on a disk. Electronic mail, for example, is a widely popular manner of transmitting messages over communications networks. Most mainframes, mini computers and computer networks have an e-mail system. Some electronic mail systems are confined to a single computer system or network, but others have gateways to other types of computer networks. Companies that are fully computerized make extensive use of e-mail because of its speed, flexibility and reliability.

Another type of communication technology is known as instant messaging (IM). In recent years, IM technology has proliferated throughout the internet-enabled world population and is also finding its way into private/public corporations and businesses. IM differs from an e-mail service in a number of important aspects, one of which is that individuals using e-mail have no idea if the recipient is actually at the other end ready to receive the message. IM users, on the other hand, know who is “online” and who is not. As its name implies, an IM allows an individual to “instantly” know who is available to exchange information. Because of this, it's an extremely useful collaborative tool that has virtually exploded in popularity among users of the internet.

Various types of instant messaging systems are currently available from competing providers, such as Instant Messenger available from America Online, Inc., Yahoo! Messenger available from Yahoo!, Inc. and ICQ available from Mirabilis, Ltd., to name a few. Typically, these communication services enable a user to initiate a chat session with another individual by providing a private list and alert a user when someone on his/her private list is online. Some of these IM architectures also provide the capability of sending messages to other recipient users, regardless of their online status, whereby the associated network server functions to temporarily store the message in the event the intended recipient is not logged on. Inherently, however, such a capability makes the IM system susceptible to eavesdropping, identity theft, etc. Other vulnerabilities can be attributed to the fact that messages and files may be sent unencrypted and some IM architectures use a third party server to route traffic and store these messages. As such, IM traffic can be sniffed and spoofed since the end user is not necessarily authenticated.

Accordingly, there remains a need to provide a new and improved secure instant messaging tool that does not have the inherent vulnerabilities that are presently found in various brands of IM technology now available in the market. There is a need for a secure instant messaging tool that does not necessarily utilize a third party server to store IM traffic or file transfers, but rather resides inside a computer network behind a firewall, and functions primarily to route encrypted traffic. By employing this type of architecture in conjunction with strong encryption, the ability to sniff or spoof the message traffic can be rendered virtually impossible.

### SUMMARY OF THE INVENTION

It is an object of the present invention to provide a new and useful computerized instant messaging (IM) methodology for securely transmitting data over a network infrastructure from a sending client computer system to a recipient client computer system.

Another object of the present invention is to provide such a methodology, which incorporates multiple encryption layers to optimize security of the transmitted data.

It is also an object of the present invention to transmit encrypted data to a recipient client computer system after confirming the recipient client computer system is willing to receive the data stream.

A further object of the present invention is to provide a computer-readable medium adapted for use as a component of a client computer system used in a client/server instant messaging (IM) environment.

Yet another object of the present invention is to provide a new and useful data structure stored on a computer-readable medium.

A still further object of the present invention is to provide a new and useful graphical user interface (GUI) for providing and selecting from menus on a display.

It is also an object of the present invention to provide a new and useful client computer system as a component in a client/server messaging application implemented over a network infrastructure.

In accordance with the foregoing objectives, the present invention provides both a methodology and various components for securely transmitting data over a network infrastructure between computer systems. The network infrastructure, in a simplified form, may be only a pair of computer systems capable of communicating with one another through a server. However, the ordinarily skilled artisan will appreciate that the present invention can be readily implemented on a variety of networks defined by characteristics including topology, protocol and architecture. It is anticipated that the present invention, though, might be more particularly suited for implementation on an organization's intranet which is protected by a firewall and intended to be accessible only by authorized members. This, however, should not be unduly construed as limiting the environment of the present invention since the skilled artisan familiar with the seven layer OSI model and its various protocol suites, cryptographic systems, programming languages and network administration in general, will understand that the present invention can be readily extended to any type of network infrastructure where security of data transmissions is of interest. This may include, for example, a combination of resources on an intranet and extranet or even those associated with the global internet given the ability to lease hardware devices and communications channels.

With this in mind, the present invention in one sense contemplates a computerized instant messaging (IM) methodology for securely transmitting data from a sending client computer system to a recipient client computer system, each being logged on to a common network infrastructure and having associated client application installed thereon. The network infrastructure also preferably includes a network server having an associated server application program installed thereon. In accordance with the methodology, plain text data is selected for encrypted transmission from the sending client computer system to the recipient client computer system. Encryption of the plain text data takes place at the sending client computer system according to a selected cryptographic algorithm utilizing an encryption code, thereby to generate ciphertext data correlated to the plain text data. This ciphertext data is sent as part of a data stream along a secure connection established between the sending client computer system and the recipient client computer system whereby it is routed through the network server without the network server or any other device archiving a record of the ciphertext data. By this, it is contemplated that the network server functions analogously to a router so that it neither stores nor retains a copy of the underlying ciphertext data beyond the time necessary to verify that it has reached its intended destination. Once the ciphertext data reaches the intended destination at the recipient client computer system, it is decrypted according to a selected decryption algorithm which utilizes a decryption code, thereby to make the plain text available for viewing on the recipient client computer system.

For purposes of the description to follow, it should be understood that the term “data” contemplates either a message in the form of plain text, which is typed on a computer keyboard, or plain text information contained in a file stored on a computer system. It should also be understood that the terms “encryption code” and “decryption code” each contemplate any of a variety of encryption techniques or algorithms, such as keys or pass phrases, to name on a few, for use in converting the plain text data into ciphertext. In the preferred form of the invention, public and private RSA encryption keys may be used where the transferred data is in the form of a message, while pass phrases are be used where the transferred data is located in a file which is to be instantly and securely transmitted between a sender and a recipient.

In a preferred form, a secure connection with the network server is established via SSL when a user logs on. When the transmitted message is in the form of a file that has been selected for encrypted transmission to a recipient user, the sending client issues a request to the server to establish a virtual connection between the sending client and the recipient client whereupon the server creates a tunnel environment between the two. Thereafter, the cyphertext version of the selected file is sent to the recipient user via the SSL connection and along the virtual tunnel. However, a virtual tunnel environment is not employed for encrypted transmission of a plain text message that has been typed in by the sending client.

As for the encryption of the “data”, whether in the form of plain text or a file, this data is encrypted at the sending client computer system with an encryption code associated with the recipient client computer system, and ultimately decrypted at the recipient client computer system with a decryption code associated with the recipient client, such that the encryption code and decryption code define a code pair. Of course, symmetric encryption could be employed utilizing identical codes, but this is not the preferred cryptographic approach since the system may be more vulnerable to attacks. Again for secure message transmission, the encryption and decryption codes are, respectively, public and private keys, while the encryption and decryption codes can include pass phrases for secure file transmissions.

Additional security may be employed by ensuring that the recipient client computer system has given prior authorization for transmission of encrypted data in the form of a file. This can be accomplished by the sending client computer system initially transmitting a send data request to the recipient client computer system seeking permission to transmit encrypted data. Transmission of the ciphertext data to the recipient client computer system, thus, would only occur in the preferred embodiment if the recipient client computer system transmits a reply to this request granting permission to transmit the encrypted data. An additional level of security can also be employed by ensuring that the recipient client is selected by the sending client from a pool of users identified on the sending client computer system as being authorized to receive encrypted data transmissions and, similarly, that the sending client computer system is one of a pool of users identified on the recipient client computer system as being authorized to transmit encrypted data. These authorization preferences can be used in conjunction with, or separate from, a formal request/reply message exchange between them.

Once the plain text data has been encrypted at the sending client computer system, routing information associated with the recipient client computer system is pre-pended to the ciphertext data thereby to form the data stream. This data stream is preferably sent to the network server over a first secure socket layer (SSL) connection established therebetween. Once received by the network server, its associated server application program operates to compare the pre-pended routing information with stored routing information associated with the recipient client computer system to determine if a match exists. Assuming this to be the case, the network server replaces the recipient client's pre-pended routing information with routing information associated with the sending client computer system prior to forwarding the ciphertext data to the recipient client over a second SSL connection established therebetween. Upon receipt of the data stream, the recipient client computer system compares the sending client's pre-pended routing information with stored routing information associated with the sending client computer system to determine existence of a match. It then operates to decrypt the ciphertext data only if a match exists. Once the last bit of data has been received by the recipient client, all secure connections between the sending a recipient clients are severed. Of course, both the sending and recipient clients, however, would remain securely connected to the server until their respective program are shut down.

A computer-readable medium adapted for use as a component of a client computer system in a client/server instant messaging (IM) application is also provided. The computer-readable medium has computer executable instructions operative upon execution to receive from the network server first data representing those authorized users of the IM application who are connected to the network server, thereby to define a group of logged-on users. A monitor is controlled to display perceptible output of a first characteristic to identify the group of logged-on users. Upon receipt of a logged-on user selection signal, indicative of an identified logged-on user being selected by the computer system's data input device, the monitor is controlled to display at least one of a message entry field and a file designation field. Where a message entry field is displayed, message entry signals from the data input device, such as a mouse or a keyboard, are received which correspond to entry of unencrypted data in the message entry field that is intended for encrypted transmission to the identified logged-on user. Where the file designation field is displayed on the monitor, file designation signals are received from the data input device representing location of a data file containing unencrypted data intended for encrypted transmission to the identified logged-on user.

Following receipt of a send selection signal from the data input device, the computer executable instructions are operative to encrypt the unencrypted data according to a selected cryptographic algorithm, thereby to generate ciphertext data. The ciphertext data and routing information associated with the identified logged-on user is then caused to be transmitted as a data stream, along a secure connection via the network server, to a remote one of the client computer systems that is associated with the identified logged-on user.

The computer executable instructions associated with the computer-readable medium are also operative upon execution for receiving from the network server second data representing those authorized users of the IM application who are disconnected from the network server, thereby to define a group of logged-out users, and to control the monitor to display perceptible output of a second characteristic different than the first characteristic to identify the group of logged-out users. They are also operative to receive from the network server a first sub-set of data corresponding to a send data visible group of logged-on users and a second sub-set of data corresponding to a send data invisible group of the logged-on users. Here, the send data visible group identifies those logged-on users to whom the client computer system is permitted to send encrypted messages, while the send data invisible group identifies those logged-on users to whom the client computer system is prohibited from initiating encrypted data transmissions. Preferably, transmission of the data stream to the network server and beyond only occurs upon a determination that the identified logged-on user is a member of the send data visible group. Third and fourth sub-sets of data may also be received corresponding, respectively, to a receive data visible group of logged-on uses and a receive data invisible group of the logged-on users. Here, the receive data visible group identifies those logged-on users who are permitted to send encrypted messages to client computer system, while the receive data invisible group identifies those logged-on users who are prohibited from initiating encrypted data transmissions destined for the client computer system. The executable instructions are operative to transmit the third and fourth sub-sets of data from the client computer system to the network server.

The instructions are also operative upon execution to monitor a communications interface to detect incoming data streams from the network server containing current status information relating to the group of logged-on users, logged-off users, send data visible group of logged-on users and send data invisible group of logged-on users, and to store this status information within the computer system in respective memory locations. The instructions also monitor the communications interface to detect incoming data streams corresponding to an encrypted message originating from an associated remote one of the client computer systems, where each encrypted message includes associated ciphertext data and a pre-pended routing identification associated with the remote client computer system. A determination is made with respect to each detected data stream as to whether a match exists between the pre-pended routing information and stored routing information. Decryption of the received ciphertext data preferably only occurs upon existence of a match.

A computer system is also provided to process information according with the methodology performed by the computer executable instructions. Here, a client computer system is provided as a component in a client/server messaging application implemented over a network infrastructure and comprises a storage device, at least one data input device, a monitor, and a processor which is programmed in accordance with the foregoing computer-readable medium methodology.

A somewhat different embodiment of a computer-readable medium according to the present invention has a data structure stored thereon which comprises a plurality of record entries each associated with a respective authorized user of the messaging application. Each record entry minimally comprises a first field, a second field and a resultant field. The first field contains data representing a connection status for each respective authorized user to indicate that the respective authorized user is either connected to or disconnected from the network server. The second field contains data representing a visibility status for the respective authorized user to indicate whether he/she is permitted to send encrypted data to the client computer system. The resultant field contains data representing a set of message exchange capabilities between the client computer system and the respective authorized user, and is derived as a correlation of at least the first and second data fields.

Each record entry in the data structure may also include a third field containing data representing an encryption key for the respective authorized user, with the resultant field derived as a correlation of the first, second and third fields. A fourth field may also be included to contain data representing a routing identification number for the respective authorized user.

Finally, a computer system is provided having a graphical user interface (GUI) for providing and selecting from menus on a display according to a methodology. This methodology comprises retrieving from a storage device a global set of entries each representing a selected one of the authorized users of the IM application. A first group of entries is retrieved from the global set of entries for a first listing. Each entry within the first group represents a selected one of the authorized users who is currently logged-on to the network server and who is visible to the client computer system. The first group of entries is displayed on the monitor as a first group perceptible output having a first characteristic (such as a blue color), thereby to indicate users who are available for receiving encrypted data transmissions from the client computer system. Upon receipt of a first group selection signal, indicative of the input device identifying an authorized user by designating a selected entry from the first group, an associated first set of menus entries for the identified user is retrieved from the storage device. Each of these menu entries represents an available action with respect to the identified user and is displayed on the monitor. A menu entry selection signal may then be received from the input device corresponding to the input device designating a selected entry from the associated first set of menu entries.

It is preferred that one of the available actions represented by the first set of menu entries correspond to either a send message option or a send file option. Accordingly, when the menu entry selection signal corresponds to the input device designating the send message option, a message entry window is displayed on the monitor. Similarly, when the menu entry selection signal corresponds to designation of the send file option, a file designation window appears on the monitor. Other available actions may include an ability to view prior correspondences associated with the identified user, or rename the identified user.

The GUI methodology may also retrieve from the global set of entries a second group of entries for a second listing, with each such entry representing a selected one of the authorized users who is logged-off the network server. The second group of entries is also displayed on the monitor as a second perceptible output having a second characteristic different than the first characteristic (such as a red color), thereby to indicate users who are unavailable for receiving encrypted data transmissions from the client computer system. Preferably, the first and second groups of entries are arranged on the monitor as a vertical listing of names each corresponding to an associated one of the authorized users. Preferably also, the first and second group of entries may be displayed on the monitor against a background resembling the front cover of a computer case.

Also in accordance with the GUI methodology can be detection of incoming messages and a determination, with respect to each incoming message, as to whether it originated from one of the authorized users represented by the global set of entries. If so, then the perceptible output on the monitor is changed (such as to a yellow color) to provide an alert indicative of the incoming message. An audible sound may also be used.

The GUI methodology may also include performing a search of the computer system's storage device to locate data corresponding to a public key associated with the identified user. If the public key cannot be located, then it displays within the associated first set of menu entries an available action corresponding to an ability to obtain the public key for the identified user. Also, the perceptible output associated with the identified user can be in a color which is distinguishable from the first and second perceptible outputs (such as a purple color) to indicate that the key identification is presently unavailable. In addition also, a set of entries can be obtained from the global set to represent selected ones of the authorized users who are currently logged-on to the network server, yet invisible to the client computer system, such that the client computer system is not permitted to transmit messages to them. Preferably, the monitor is caused to generate perceptible output corresponding to the second color for each authorized user represented by this set of entries. As such, it is preferred that there be no distinction on the computer system's monitor between users who are logged-off the network server and users who are logged-on the network server yet invisible to the client computer system. Of course, it should be appreciated that a distinction could be made, if desired, by simply causing the perceptible outputs associated with logged-off users and invisible, logged-on users to be different.

As will be appreciated from the description to follow, the core technology described herein encompasses the action of encrypting data and sending it over a network via a secure communication link. The encryption engine discussed herein may comprise two components (the encryption component and the secure network sockets component), and uses a multi-tiered approach to it's security. These tiers, or layers, may include two layers of encryption and the SSL communication layer.

The encryption component of the engine encrypts and validates data of all types (i.e. messages, files, etc.). The encryption component itself can be comprised of one of three layers: RSA key encryption, biometric encryption, and other encryption types which may include algorithms such as, Twofish, Blowfish, DES, Triple-DES, AES, MD5 and SHA1. Of these algorithms, one or more may be chosen and configured by the implementer to best suit his/her needs, such key generation and/or pass phrase generation. If implemented, biometric encryption could be added to or used to replace one of the foregoing encryption types.

The biometric implementation can be broken down into two types: one that uses the biometric template (i.e. the resultant code from a finger print scan) as the key/pass phrase for a particular algorithm, or another which uses the biometric as a layer of validation to the secure communication. Where biometric is used for the first layer of encryption, one can choose, for example, the Blowfish algorithm for the second layer of encryption. For example, if one chooses biometrics, one can place his/her finger on a finger print reader, with the resultant template code being used as the pass phrase.

The second component that encompasses the encryption engine is the secure communication component. This component will enable the implementer of the technology to create an encrypted communication socket between the server and its respective clients. This component preferably utilizes secure socket layer (SSL) technology which has been adopted as an industry standard for secure network traffic. Added security can be provided by using the SSL implementation in conjunction with the above mentioned encryption algorithms.

Aside from the secure instant messaging system discussed herein, various other types of approaches which implement the technology are contemplated. One such example is a biometric network identification system. It is known to utilize biometric technology to obtain secure access to a location, and to use a TCP/IP based network to validate a user. However, communication between the access point and the server are not encrypted. The encryption engine discussed herein, however, could not only encrypt the biometric data, but also create a secure link between the access point and the server thus guaranteeing the security and privacy of the data.

Another approach might be the use of the technology for network printer communication. It is known to use office printers in a network scheme whereby printers are given routable ID addresses which connect them to a network server. However, the communication between the server and printers are not secure. In fact, there is no validation that the server is the device which is actually sending the print job to the printer. Accordingly, such systems are inherently susceptible to attacks whereby the data can be intercepted as it travels from the print server to the printers. To combat this, and through incorporation of the encryption engine discussed herein, one could not only encrypt the data of the print job, but also create the secure link between the print server and the printer. Validation techniques could also be provided to ensure that the only source data for a print job is from the print server.

Yet another implementation of the technology can be in a network file sharing system. Many offices offer file sharing between computers within a network so that workers can easily share files among each other. The problem with this is that there is little security within the shared remote file, and there is no protection for the data in transit. Also, architecture currently being used can be somewhat time consuming. For example, if user A wants to send a file to user B, existing GUI environments require that user A perform multiple mouse clicks in order to ultimately arrive at the location of the file to be sent. However, implementation of the encryption engine discussed herein in such a scenario could make file transfer as simple as right clicking a mouse button on the file, selecting a user's name from the list and ultimately selecting a “send” file option. This would not only create an SSL link between user A and user B, but also encrypt the file for transfer.

Moreover, the technology can be designed to be portable for use in many different kinds of applications. For example, the encryption engine can be implemented as software linkable library components. This would allow a software designer to utilize the engine's application programming interface (API) to use the encryption in secure sockets for use in their own applications. Another avenue would be to implement the engine on computer hardware (silicone, transistors, firmware, etc.) so that the encryption and communication would be embedded at a faster, more permanent state. The updates to hardware could be done via firmware.

These and other objects of the present invention will become more readily appreciated and understood from a consideration of the following detailed description of the exemplary embodiments of the present invention when taken together with the accompanying drawings, in which:

### BRIEF DESCRIPTION OF THE DRAWINGS

FIG. 1 is representative of a network topology which may provide the infrastructure for implementing the principals of the present invention;

FIG. 2 is a diagrammatic view of a simplified network topology, which includes a network server and two client computer systems, for implementing the present invention;

FIG. 3 is a diagrammatic view to illustrate the flow of data from a sending client computer system to a recipient client computer system on the network infrastructure illustrated in FIG. 2;

FIG. 4 is a flowchart illustrating some of the principal concepts according to a methodology whereby a sending client computer system transmits encrypted data in the form of a plain text message to a recipient client computer system;

FIG. 5 is a diagrammatic view illustrating some of the messages which are broadcast between the sending and recipient client computer systems in accordance with the methodology shown in FIG. 4;

FIG. 6 is a flowchart to illustrate some of the principal concepts employed during transmission of encrypted data in the form of a file between a sending client computer system and a recipient client computer system;

FIG. 7 is a diagrammatic view illustrating some of the messages which are broadcast between the sending and recipient client computer systems during implementation of the methodology shown in FIG. 6;

FIG. 8 shows a representative floating panel which may be displayed on a client computer system, such as User A's monitor, during execution of the client application software;

FIG. 9 illustrates a representative main application window which may be displayed on a client computer system during execution of the client application software;

FIG. 10 illustrates a representative menu of entries available for a selected authorized user of the IM application, as it may appear on one of the client computer systems;

FIG. 11 illustrates a representative message dialog window for use with the IM application;

FIG. 12 shows a representative receive message dialog window for use with the IM application of the present invention;

FIG. 13 illustrates a representative reply message dialog window for use with the IM application of the present invention;

FIG. 14 illustrates a representative file designation window for use with the IM application of the present invention;

FIG. 15 illustrates a representative history window which may be displayed during use of the IM application of the present invention;

FIG. 16 shows a representative pull down menu which may be accessed from the main application window of the present invention, which pull window corresponds to various status options available to an authorized user of the client computer system;

FIG. 17 illustrates a representative menu window which may be accessed from the main application window during use of the IM application of the present invention; and

FIGS. 18(a)-18(e) each show a representative tab sheet of user preferences which may appear during use of the IM application of the present invention.

### DETAILED DESCRIPTION OF THE EXEMPLARY EMBODIMENTS

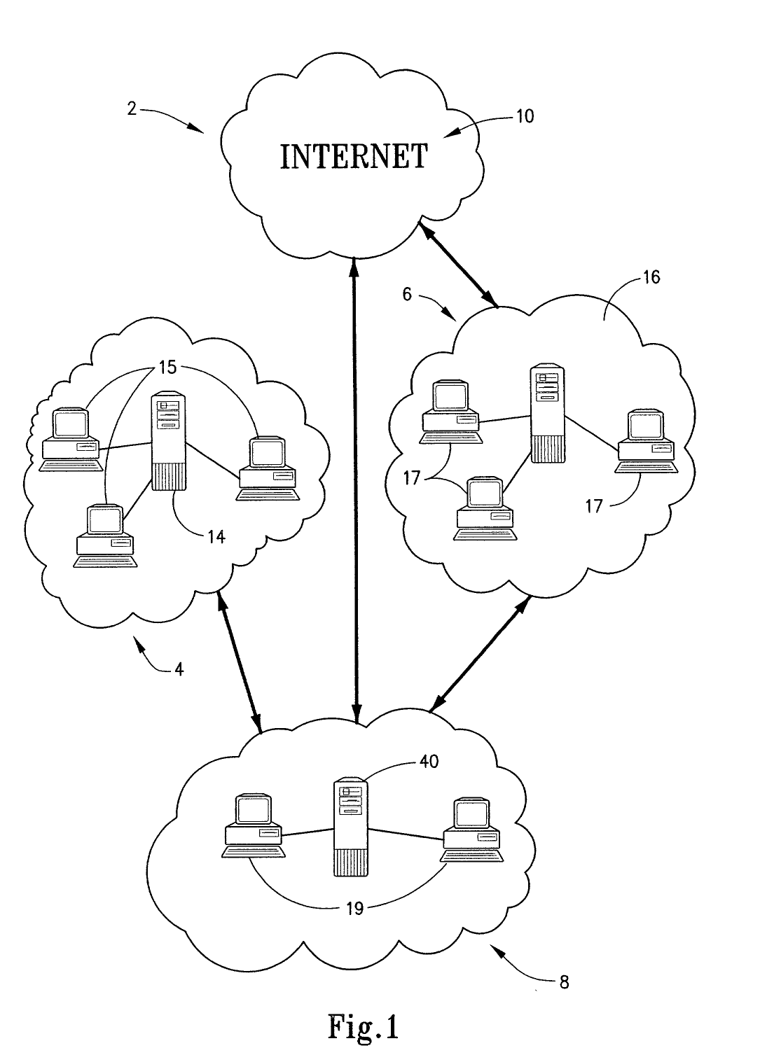

A representative network topology for implementation of the present invention is generally introduced in FIG. 1. Of course, as discussed above, the particular network topology could take on a variety of configurations so that FIG. 1 represents only one possible environment for the present invention. Representative network 2 includes a plurality of intranets or extranets 4, 6 and 8, which may have communications interfaces with the public internet 10. For purposes of describing the environment of the present invention, each of intranets 4, 6 and 8 may be a localized LAN associated with various divisions of a corporation so that together they comprise a larger corporate intranet. Each LAN 4, 6 and 8 may be protected by an associated firewall to limit access to network resources to only authorized members. Each of LANS 4, 6 and 8, respectively, includes an associated network server 14, 16 and 40 to which is connected a plurality of nodes in the form of client computer systems 15, 17 and 19. Understandably, hubs, routers and gateways as well as a variety of other hardware and software components would be present to permit communication capabilities between the various LANS and the public internet 10. To facilitate an understanding of the description of the present invention, the discussion will primarily describe the invention in the environment of a simplified LAN, similar to LAN 8, having only two client workstations, but at times will describe the invention in the context of a more complex network having several client computer systems each associated with a respective authorized user.

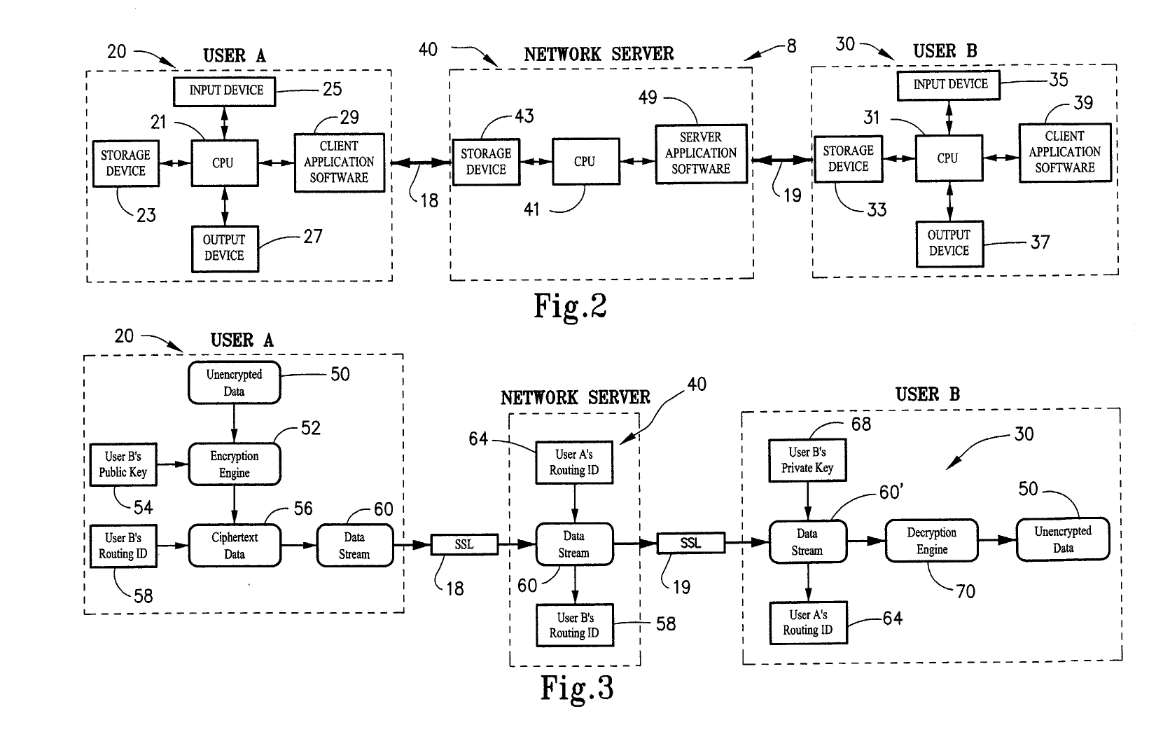

With this in mind, and with reference now to FIG. 2, the present invention may be implemented on a network 8 such as that generally depicted in FIG. 1. User A has an associated client computer system 20 which includes a central processing unit 21, a storage device 23, an input device 25, an output device 27 and associated client application software 29. Input device 25 can actually be one or more different types of input devices, such as a keyboard and/or a mouse, to provide data input to client computer system 20. Output device 27 preferably includes at least a display device, preferably in the form of a monitor, for displaying perceptible to User A, but may also include audible output capabilities through speakers for use in conjunction with the display monitor. Storage device 23 may be a variety of different types of computer-readable media, such as CD-ROMs, DVDs, magnetic tapes, etc., but preferably includes at least a hard drive so that User A's application software 29 can be stored in executable form on the computer system 20. Computer system 30 is associated with a respective authorized user, User B, and similarly includes a CPU 31, a storage device 33, an input device 35, an output device 37 and associated client application software 39.

Each of client computer systems 20 and 30 is configured to communicate with one another and with network server 40 via communications links 18 and 19. Of course, the ordinarily skilled artisan would understand that the term communications link is intended to encompass any of a variety of communications interfaces (Ethernet cabling, telephone lines, wireless communications channels, etc.) for allowing data transmissions between the client computer systems and the network server. As will be understood in the description to follow, network server has somewhat limited functions such that its associated computer system 40 could minimally include an associated CPU 41, a storage device 43 and associated server application software 49. The network server 40 primarily acts as a router for secure data transmissions between Users A & B, but is also adapted to receive and broadcast various status information during use of the client/server instant messaging application.

The source code for the secure IM software was built using Borland's C++ Builder 5 Professional C++ Builder 5 Professional includes its own compiler for converting the high level C++ programming language into machine code. As would be understood by those familiar with Borland's C++ Builder, various code objects referred to as “forms” are design-time objects that appear as windows or dialog boxes when the client applications are running. Some of these code objects, those beginning with the letter “T” are specific to the Borland C++ Builder compiler and are selected from a visual components library framework. Other development tools used to build the source code for the client and server application software included the TurboPower's LockBox encryption software, and MySQL open source database available from MySQL AB.

The application software programs for the clients include separate modules, comprising a main application module which controls the main flow of the programs and makes functions calls to various other modules as necessary during run-time. The server application software program preferably includes only a main program module. The modules for the client and server applications are combined when the software is linked. The various programming modules are listed below:

main.cpp (client code file)

pref.cpp

visiblility.cpp

rmsg.cpp

reply.cpp

sfile.cpp

smsg.cpp

splash.cpp

histry.cpp

main.cpp (server code file)

Of course, the ordinarily skilled artisan who is familiar with programming environments would recognize that other high-level languages, such as Basic, Cobol, Fortran, ADA and Pascal could be used for organizing the program instructions. Alternatively, various low-level languages or assembly languages could be used to provide the syntax for organizing the programming instructions so that they are executable in accordance with the description to follow. Thus, the preferred development tools used by the inventor should not be interpreted to limit the environment of the present invention.

Once the client application software and the server application software have been compiled they are preferably distributed on a computer-readable medium, such as on one or more CD-ROMs, DVDs, magnetic tapes, etc., so that they can be installed on the various client and server computer systems associated with the secure IM system. For example, the client software could be distributed on its own CD-ROM so that it can be installed on the respective client computer systems associated with the IM application, while a separate CD-ROM could be provided for the executable server application software that is to be \installed on the network server. The server itself is preferably a WIN 32 service that is to be run on a Microsoft Windows NT or Windows 2000 platform since Windows services contain service threads that spawn when the service is called to start. Of course, the ordinarily skilled artisan would recognize both that the client and server software programs could be installed in other manners, such as downloading them to the appropriate terminals through a web interface or the like, and that other computer platforms such as Unix and Linux could provide the environment for the present invention.

In any event, the description to follow presumes that the client application software has been installed on the respective platforms for the client computer systems and the server application software has been installed on a appropriate server machine, each of which resides as a respective node on the appropriate network so that the server is accessible by all client users having valid IP addresses. The server's IP address would be set by the administrator or other appropriate person when the client application software is installed on the client computer systems. Further, if it is desired that the various clients communicate with one another over a secure socket layer (SSL) connection established therebetween, then it is understood that an appropriate certificate authority would need to be contacted to obtain public and private keys that will enable the SSL feature so that an appropriate public/private key pair for each authorized user can be generated and stored on the individual's hard drive, all as is known in the art.

### Initialization

A. Server Side

Since, in the preferred embodiment, the network server operates in a WIN 32 environment with the Windows services containing service threads that spawn when called to start, the code for the server application software is executed from each thread's execute function. When the server application program is run, it initializes a listing of all connected users that are stored in a vector in memory on the server, and it activates a TCP Server function within its main program to listen for connections. TCP Sever is essentially a data structure that links to a Borland function that contains the code that will listen for incoming requests from clients, and establish an SSL communication link between the client and server. The data structure contains the port number the server should listen on, the SSL intercept function to call to enable SSL, and any bindings that might be associated with that port. An appropriate function opens the server's registry and loads the locations for the root certificate, client certificate, server key and the boolean value for SSL. The SSL boolean value will tell the server's software application whether the value for the certificates is important. If the SSL feature is enabled, then the certificates obtained from a certificate issuing authority are loaded into the application to be used by the TCP server's intercept. Once initialized, the TCP server's job is to listen preferably on port 5050 for all incoming requests and to process the information.

When a user initially connects to the network server, a function within the server's application program is called to create an instance of a code object which adds a temporary value for the user's client ID, name and status variables. The connecting thread's value and thread data are stored in the instance variable for tracking use, and the instance variable is stored in a client listing.

B. Client Side

Once the program has been installed on the various client computer terminals, it may be conveniently accessed via a shortcut icon presented on the user's desktop or, alternatively, by browsing through the appropriate file structure on the computer's hard drive and locating the IM executable file. Once started the application goes through an initialization sequence to prepare for operation. Prior to this, the user is logged off the network server in a disconnected state. Assuming, for example, User A wishes to run the program, the program initially determines User A's screen resolution so that it can scale itself to the proper size. Preferably, the screen resolution needs to be at least 800×600 or the application will quit with an error. Upon completion of the screen test and scaling the program makes a Windows application program interface (API) function call to warp the look of the window into one with rounded corners. A function is then called to load the embedded lock and unlock codes, initialize the listing of clients/users and to deactivate the floating environment option. The floating option refers to the application having small floating panels, such as floating panel 201 in FIG. 8, present on the monitor with an authorized user's name on each of the panels so that the application does not have to be visible to the user at all times. Accordingly, the default is to turn this floating off, yet allow the user to enable floating panels associated with other users by modifying his/her preferences.

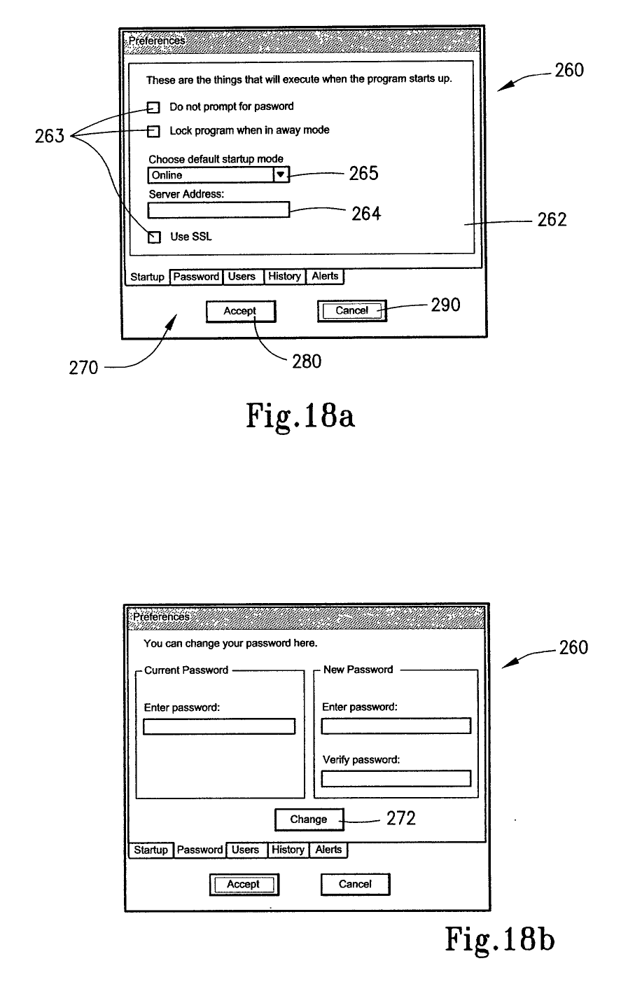

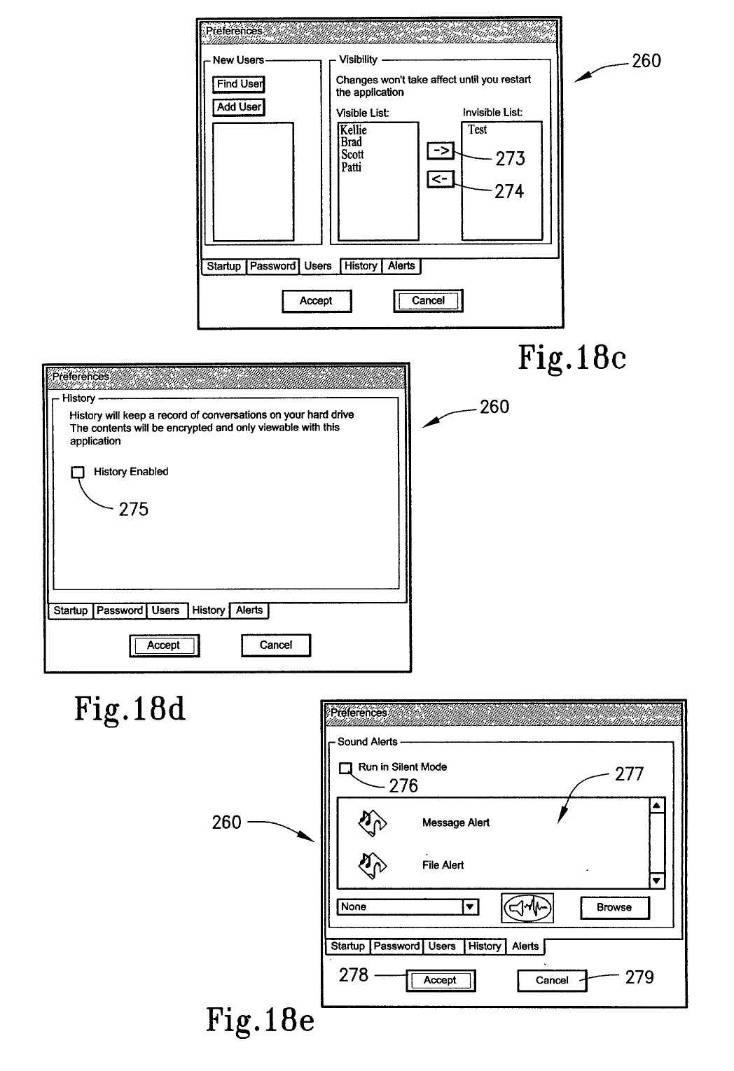

A new instance is then created for the design-time object form that relates to the window for User A's preferences. As would be understood by those familiar with programming in general and high-level object oriented program in particular, design-time objects may be created in the code as forms, and these design-time objects are distinguishable from run-time objects that appear as windows or dialog boxes when the application is running. In any event, when a new instance is created for the form corresponding to the preferences window, it prepares the application to load the various variables used when User A accesses the preferences dialog window. The various preferences available to client A and the other client computer systems authorized to use the IM application will be discussed in greater detail with reference to FIGS. 18(a)-18(e).

Another design-time object corresponding to the program's splash screen is then created and executed. Upon execution of this program module [splash.cpp], a splash screen appears containing an appropriate logo and a progress bar to let User A know how much time is remaining while the application configurations are loaded. Initially, then, the splash screen appears when the application first starts up and loads the components that are necessary for it to run. This, of course, could all take place behind the scenes so that it is transparent to the user. The application first increments the progress bar and opens the computer system's registry to look in the “HKEY_LOCAL_MACHINE\Software\” directory to determine if the appropriate keys exists. If not, then the application returns an error stating to User A that it has been altered and must be reinstalled. If the appropriate keys are in place the application proceeds to retrieve the values for the application's lock code, the user's name, the user's assigned ID and the user's password. The lock code is an alphanumeric code telling the application whether it should be locked or unlocked. If the code is set to lock, the application will prompt User A for the password before any interaction with the application. User A's password is created upon installation of the client application software and is preferably encrypted using the Blowfish encryption algorithm which comes with the TurboPower's LockBox encryption suite., although other encryption algorithms could be employed. The lock code, the user name, user ID and user password are stored in variables for later use.

The progress bar increments another step and makes a function call to decrypt User A's password. All encryption and decryption functions utilized by the application may be located in “.dll” and “.lib” files so that they are conveniently available to the application via appropriate function calls. The function call then takes the ciphertext corresponding to User A's password and a pass-phrase that is embedded in the application, and decrypts the ciphertext. In the preferred embodiment, the decryption algorithm utilizes a full 128-bitkey and a pass-phrase that is a 512-bit string created by the system administrator during set-up. Assuming User A's password is successfully decrypted, the plain text password is returned and stored in a variable for later use. The progress bar is again incremented.

The application then prepares to open an initialization file by creating an instance of a function call to allow the application to read and write to the “.ini” file. Upon completion of this instantiation, the progress bar is again incremented. All of the values for the “.ini” file are read into the application and stored in variables for use during execution. The application then deletes the instance of the initialization function call and increments the progress bar accordingly. Next, the program opens a data file which contains a listing of all the visible users. For purposes of the description herein, a “visible” user identifies the other client computer systems that have been permitted by User A to transmit encrypted data to User A, such as encrypted messages or encrypted files. Accordingly, it should be appreciated that, upon installation of the client application software a user can identify those other authorized users of the IM application who are permitted to initiate data transmissions to the user, such that he/she is “visible” to them, and can make modifications to this listing as desired. The program proceeds through the visibility data file reading in all the names of the visible clients and adding them to an appropriate visible listing until the end-of-file (EOF) character has been reached. The same thing occurs for a data file corresponding to those users who are “invisible”. The invisible data file identifies other authorized users who, from User A's perspective, are not permitted to initiate data transmissions such that User A is invisible to them. Again, the invisibility listing is initially established upon installation but can be modified as necessary by User A.

During operation, the visibility status is used in conjunction with the visibility modes that User A has set. There are three modes of choice “online”,“invisible” and “away”. If User A is “online”, then all of the other users, regardless of their visibility status, can see that User A is online. If User A's visibility is set to “invisible”, then only the Users who are on User A's visible list will see that he/she is logged-on. It will appear to all other users that User A has logged off. User A can still transmit data to other users on his/her invisible list, and they can read and respond to those messages, but they cannot initiate a message or send a file. Upon completion of reading the appropriate data files, the splash session is terminated, the instance of the splash form is deleted from memory, and control is returned to the main program module [main.cpp].

The application then goes through a series of tests to determine what was loaded by the splash session. The first thing that is checked is the lock code. If the lock code variable is the same as the imbedded lock code, then a password dialog window appears and nothing will continue until a correct password is entered by User A. The program then checks to determine if SSL has been enabled. If so, then User A's transmission control protocol (TCP) intercept is enabled and set to read an SSL encrypted data stream. The application proceeds to open a data file containing a list of all authorized users of the IM system. Each entry contained in this data file is the following format:

Name:ID:Key(yes/no)

As these entries are being read in, a function call is made to generate the appropriate user panels. The first thing this function call does is parse each entry in the user's data file to separate the name, ID and key value. The key value corresponds to an encryption key for the associated authorized user. A panel is created behind the scenes for each user with the caption of the panel set to the user's name. The panel's width and height are set relative to the offset of the initial scaling, and the panel's position is set according to the current number in the loop as the user's data file is read. Once each user panel has been created, a new code object referred to herein as “MyClients” is created and the name, ID and key value for the respective user is stored in the “MyClients” code object which is then added to a listing named “ClientList”. This continues until the loop has reached the (EOF) character in the user's .dat file.

Once all of the user panels have been created, the application checks User A's mode of choice to determine his/her status. The status is stored in a variable having an appropriate value to indicate whether User A's status is set to “online”, “invisible” or “away”. Next, the TCP host address for User A is set to the variable for the server's address and a connection is attempted with the network server. If successful, a perceptible output appears on User A's monitor or other appropriate display device which preferably resembles the front cover panel 200 of a computer case (see FIG. 9). This will hereinafter be referred to as the main application window. Status indicators 202 and 204 tell User A that he/she is connected to the network server and “online”. Once User A's application software has been initialized, User A's computer system 20 is ready to receive messages from server 40 as well as other users, such as User B, and to broadcast messages to them. In the exemplary embodiment of the present invention, messages which are received at User A's computer system (whether originating from the server or other users) generally have the form “/srv-*”, while those which are broadcast to the server or other remote users from User A's computer system are generally of the form “/msg-*”.

### Periodic Status Updates from the Server

Once User A's application has initiated and connected to the network server, a timer object within his/her associated application software is started and monitors the computer system's connected socket to detect a presence of incoming messages from the network server. The timer code object for the most part runs constantly when enable and, depending on the type of message received, passes the received message to the appropriate function within the main program for handling. An exception to this occurs in the situation where User A's application is preparing to accept an encrypted file stream from another user, in which case the timer object is temporarily disabled so that the file stream can be received.

After User A's computer system 20 connects to the server 40, the timer object broadcasts a message to the server that the user has logged-on. The server sends User A a group of entries corresponding to all logged-on users for the IM application. This listing looks as follows: “/srv-lil 10000001,10000002,10000003 . . . 1000000n”, where each sequential string of 8 bits is the routing identification (ID) for each authorized user of the IM application. Client A's application software then creates an instance of a function to search through a global set of authorized users for the IM application looking for a match to each of the above IDs. If matches are found, then the application enables the associated users' panels, such that their names are displayed in a vertical listing on User A's monitor (See FIG. 9). A determination is then made with respect to each of the above user IDs as to whether User A has their associated public key. If so, then the font color for the user's names is preferably turned to blue.

Similarly, once User A has logged-on to the network server and another authorized user of the IM application who was previously “offline” or “away” logs on to the network, then User A's application software receives a message from the server in the form “/srv-li 1000000n” corresponding to the routing identification for the authorized user who has just logged in. In this case, User A's application software strips away the 8-bit user ID and only performs a single look up in its client listing to determine existence of a match. Thereafter, User A's application software now enables the panel associated with the newly logged in client and turns the panel's font color to blue if User A's application software has the public key.

If an incoming message from the network is in the form “/srv-lo 1000000n”, this indicates that an authorized user has now logged out, and User A's application software will disable that client's panel and turn the font color to red, provided a match is found to the ID “1000000n”. FIG. 9, for example, depicts one possible representation of what may be viewed on User A's monitor when User A is online. In FIG. 9, a group of entries are displayed on the monitor whereby the client panel corresponding to user Scott is shown in a blue font to indicate that Scott is logged on and to indicate that User A's software application has Scott's public key. With respect to the two other users, Brad and Mike, however, their panels are displayed in a red font to indicate that they are not connected to the network server. A similar representation appears for the users from the global group of authorized user who have gone into “away” mode, at which time the network server receives a message from the remote user in the form “/msg-aw 1000000n” and forwards to User A's application in the form “/srv-aw 1000000n”. Away mode allows a remote user, for example, to remain connected to the network, but essentially appear offline to other users so that no messages are received while the user is not at his/her desk.

Although not shown in FIG. 9, the present invention also contemplates a manner for indicating to User A those authorized users of the IM application who are logged on, albeit User A is not in possession of their public key, as yet. For these clients, their associated client panels are activated and preferably turned to another color, such as purple, to inform User A of this status.

When another authorized user of the IM application chooses to be invisible to client A, a message of the form “/msg-iv 1000000n” will be sent from that user to the network server, and the network server will forward a message to User A in the form “/srv-iv 1000000n”. User A's application software, upon receipt of this message, strips away the client ID associated with the message and does a look up in the client listing to determine a match. Assuming a match exists, the panel associated with the other client's panel is disabled and the corresponding value for their visibility is set to false. The result is that User A's main application window 200 in FIG. 9 will display the remote user's panel in a red color so that the “invisible” status of the remote user is indistinguishable, from User A's perspective, from other remote users who are logged-off. User A will then be unable to initiate encrypted transmissions to the other remote user. In any event, once the appropriate status data has been received by User A's computer system from the network server and displayed, such as in the manner shown in FIG. 9, User A has various available options, as discussed below.

### Encrypted Data Transmisions

The discussion will now proceed in the context of a situation where User A's computer system 20 in FIG. 2 transmits secure data to the computer system 30 associated with a User B. This assumes, of course, that the application software 39 associated with User B's computer system 30 has also been installed properly according to User B's own preferences. FIG. 3 illustrates diagrammatically the general steps which take place when User A transmits secure data, in the form of either text messages or a file, to User B. Initially, User A's computer system 20 selects unencrypted data 50 for encrypted transmission from computer system 20 to User B's computer system 30. Unencrypted data 50 is sent to an encryption engine 52 which preferably utilizes an encryption code 54 to generate ciphertext data 56 that is correlated to unencrypted data 50. User B's routing identification 58 (sometimes also referred to herein as the ClientID) is added to the ciphertext data 56 to form a data stream 60 that is sent along a secure connection 18, preferably an SSL connection, to network server 40. Upon receipt of data stream 60, the network server's associated application software operates to strip off User B's routing identification 58 and compare this pre-pended routing information 58 with stored routing information on network server 40 that is associated with each of the authorized users of the instant messaging application. Assuming a match is found, corresponding to User B's pre-pended routing identification 58 matching that stored for User B on network server 40, the server's application software operates to replace User B's routing identification 58 with routing identification 64 associated with User A.

Once User A's routing identification 64 has been pre-pended to the ciphertext data 56, a corresponding data stream 60′ is sent to User B's computer system 30 along a second secure connection 19, also preferably an SSL connection, that has been established between network server 40 and User B's computer system 30. It is preferred in the exemplary embodiment of the present invention that network server 40 primarily serve as a router to forward the received ciphertext data to the recipient computer system. Accordingly, network server 40 caches the ciphertext data portion of data stream 60 only for a sufficient amount of time to determine if a match exists between client B's pre-pended routing identification 58 and stored routing information on network server 40. Unlike prior art messaging systems, network server 40 does not archive a copy of ciphertext data 56 or perform any processing functions with respect to it. Likewise, network server 40 does not store any of the ciphertext data on magnetic media, such as tapes or hard drives, or on optical media, such as CD ROMs or DVDs.

Upon receipt of the data stream 60′, client B's computer system 30 likewise strips off client A's pre-pended routing identification 64 to determine if this routing identification 64 matches that which has been stored on client B's computer system 30. Assuming this to be the case, then the received data stream 60′ is sent to a decryption engine 70 on client B's computer system 30 where it can be decrypted utilizing a decryption code 68 to reproduce the unencrypted data 50 and make it available for viewing on client B's computer system 30.

A. Encrypted Message Transmission

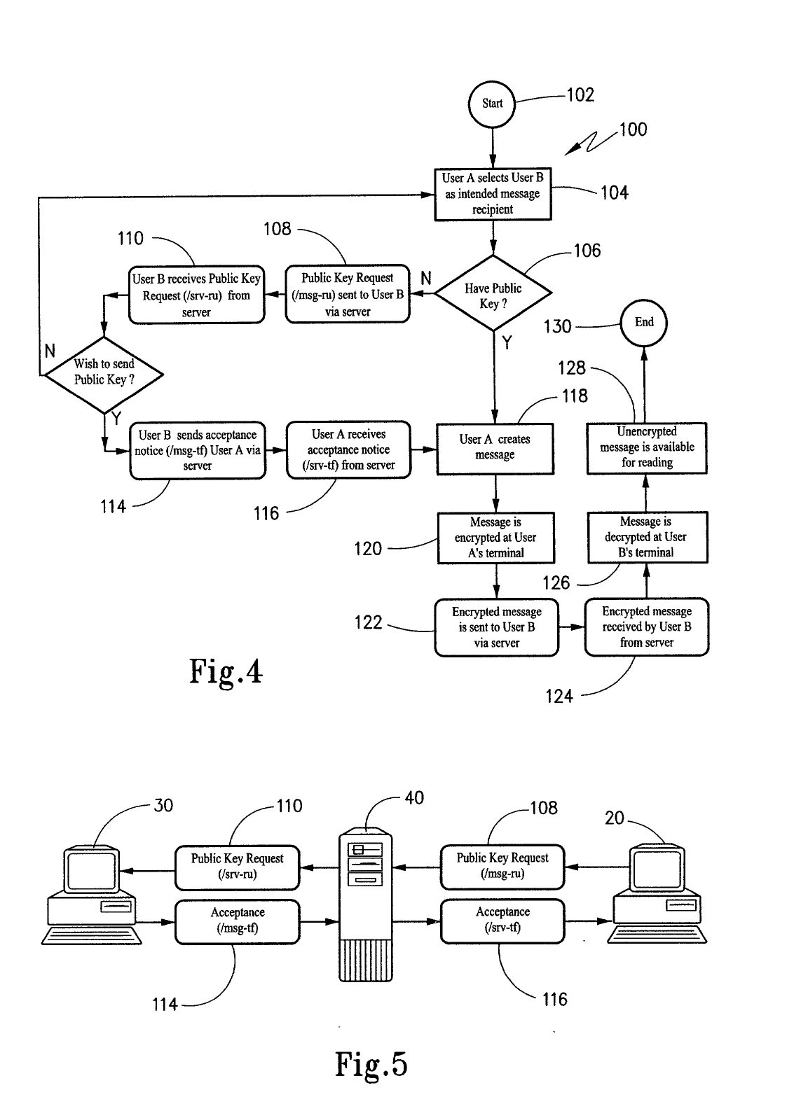

Having diagrammatically introduced the general concepts pertaining to the secure transmission of data from sending Client A to recipient Client B, a more detailed rendition of these principals can be now appreciated with reference to FIGS. 4, 5 and 9-13 which particularly relate to the situation where User A sends an encrypted plain text message to User B, such as User Scott. The general methodology steps are illustrated in FIGS. 4 and 5, while FIGS. 9-13 illustrate a possible GUI environment on the sending and recipient client computer systems as the methodology is implemented.

Methodology 100 starts at 102 and 104 where User A selects User B as the intended recipient of a message. For example, User A could select authorized User “Scott” in FIG. 9 as one of the authorized users of the IM application who is currently logged-on to the network server and who is visible to User A. More particularly, User A designates Scott as a selected entry from the first group by executing a mouse click which causes a first group selection signal to be generated. In response to this first group selection signal, the application program interface (API) retrieves from the storage device associated with User A's computer system an associated first set of menu entries for Scott, each representing an available action with respect to him. Resultantly, a pop up menu 206 appears as shown in FIG. 10 to display these available actions on the monitor. Since Scott's panel was originally displayed in a blue font, indicating that User A is in possession of Scott's public key, the available options which are displayed correspond to an ability to send a message to Scott, send a file to Scott, view prior correspondences associated with Scott, rename Scott to another name, or activate the floating panel associated with Scott. Another option identified as “confirm user” is shown in FIG. 10 but this is not available since User A's computer system is already in possession of Scott's public key. Were this not the case, then Scott's associated panel in FIG. 10 would preferably be in a purple font, and only the “confirm user” menu entry would be available to User A, such that client A would need to first obtain Scott's public key prior to being able to transmit data to him.

As would be understood by those skilled in the art, with reference to FIG. 10 and elsewhere herein, upon depressing the mouse button, User A's application software locates the position of the mouse relative to the location of the application. It then finds the object within the application that was the intended recipient of the mouse click, known as the sender. The sender, depressed mouse button, shift-state and X-Y coordinates are passed to a function within User A's application software. The sender is cast to a local instance of the panel, and the program then extracts the name of the panel and creates an instance of MyClients, which refers to a data structure in the form of a vector containing a listing of all users and pertinent status data, as needed. The program then loops through all of the clients until a match is found. When a match is found, the client object is stored in a global variable. The program then checks to see if the application is in possession of the client's (Scott's) public key, which is indicated by a boolean key value. If the program has the key, then the “send message”, “send file”, “view history”, “rename” and the “float” buttons are all enabled and the “confirm user” button is disabled. The opposite holds true if the program does not have the key. The next thing that is checked in the function whether the associated user is invisible to client A. If User Scott is invisible, then nothing happens. If User Scott is visible to client A, as is the case here, then the program examines which mouse button was pressed. If the left mouse button was pressed, then the program does nothing. If the right mouse button was pressed, then a Windows API function call is made to determine the exact location of the mouse at the time of the click. Upon locating the mouse, the pop up menu of FIG. 10 is then displayed.

Accordingly, once Scott has been selected, the methodology 100 of FIG. 4 makes a determination at 106 as to whether User A has Scott's public encryption key stored on his/her computer system. Assuming for purposes of explanation that this is not the case (i.e. assuming Scott's panel were displayed in a purple font instead of a blue font such that only the “confirm user” option is available), then the methodology proceeds to step 108 where User A transmits a public key request to User Scott. More particularly, User A transmits a message to the server of the form “/msg-ru”, which the server's application software recognizes as a request by a user who wishes to receive another users' public key. Once the server's application software recognizes that this public key request is intended for Scott (i.e. by virtue of the appropriate routing ID appended thereto), it forwards the message to Scott who receives a message in the form “/srv-ru”. Scott's application software receives the public key request at 110 and recognizes that this is a message forwarded from the server corresponding to another user's request for his public key. Scott's application software further recognizes that this request originated from User A by virtue of User A's routing identification being pre-pended to the message by the network server. If Scott does not wish to validate himself to User A, then a corresponding message can be returned.

However, assuming Scott wishes to send his/her public key to User A, then he sends an acceptance notification via the network server at step 114 in FIG. 4, and this acceptance notification is in the form “/msg-tf”. Concurrently, a file stream is created in Scott's name and with the clientID associated with Scott, whereupon the file stream which includes an encrypted version of Scott's public key is sent to the server. Again, the server's application software program recognizes that the incoming acceptance notification and associated file stream originated from Scott and forwards the acceptance notification to User A at 116 in a message having the form “/srv-tf”. Upon receipt of the file stream, User A's application software strips away the clientID to determine a match and, assuming existence of a match, temporarily disables User A's timer object until the last byte is received. At that time, the file stream is closed, the temporary memory used to store the file is deleted and a message appears to User A letting him/her know that the file has arrived. User A's timer object is then re-enabled.

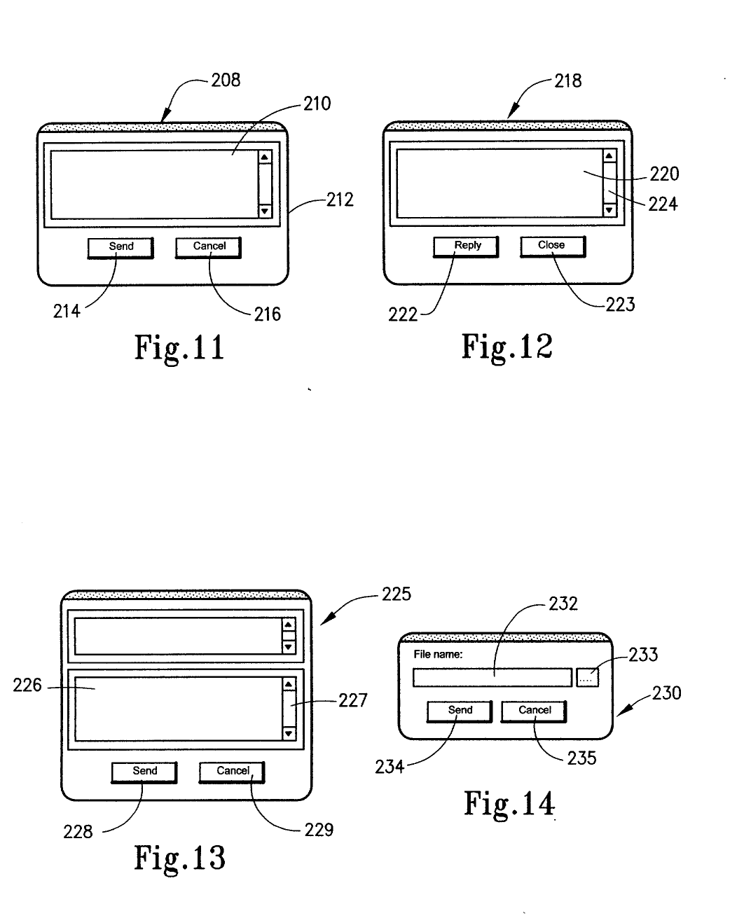

User A proceeds at 118 to create a message for transmission. For example, and again with reference to FIG. 10, User A would depress the “send message” option, causing an associated menu entry selection signal to be received. Upon depression of the “send message” button, User A's software application creates a new instance of a message dialog window. The program then scales the window to the proper size based on screen resolution, and then makes a series of Windows API calls to make a rounded window. When the preparation of the window is finished, the window is made visible [smsg.cpp], such as message dialog window 208 in FIG. 11. The message dialog window 208 contains four objects: a TMemo 210 which is used to input a message, a TBevel 212 which is used to outline the TMemo object, and two (2) TButtons, 214 and 216 respectively, that are used to send the message or close the window without sending the message.

When User A types in the message and the “send” button 214 is pressed, the methodology 100 proceeds at 120 to encrypt the message at User A's terminal. The first thing that happens is a message of the form “/msg-mt” is pre-pended to the message and then stored in a local string variable. That variable is then passed along with the local MyClients object variable that points the client's name (Scott). It should be understood that, if User A has enabled the “history” preference for Scott, then the message is also appended to a history file, such as “Scott.htf”. Once this function has completed the message dialog window of FIG. 11 is closed and control is sent back to the main application at the point of where the message dialog window was made visible. Of course, if the “cancel” button 216 is instead pressed, then a function is called in User A's application software and the message dialog window 208 is closed and control is sent back to the point in the main application where the message dialog window was made visible. It should be appreciated, of course, that User A could proceed to immediately create the message at 118 if the inquiry at 106 returns a finding that User A's computer system already has Scott's public key stored thereon. As such, steps 108-116 would be unnecessary.

Encryption of the message can proceed according to a variety of selected cryptographic algorithms which are user-defined and made available to User A's computer system upon installation of the client application software. Accordingly, the system administrator or other person responsible for installation of the IM application can choose from a number of encryption options. For purposes of this invention, these cipher suites that are available with the TurboPower packaging and which can be used include Triple-DES (3-DES), AES, and BlowFish. It is preferred that 3-DES be employed as the cryptographic algorithm since it is a cipher suite supported by SSL and utilizes an encryption key three times as long as the key for a standard DES. Both SSL 2.0 and SSL 3.0 support this cipher suite. Once the plain text message has been encrypted at step 120 in FIG. 4, it is sent at 122 to Scott's computer system via the network server. Accordingly, User A's computer system transmits a message to the network server of the form “/msg-mt” which is received by Scott's computer system at 124. As with other incoming messages associated with the IM application of the present invention, Scott's computer system strips off the first 8 bits of the message which correspond to User A's ID and executes an instance of a function call to do a look up based on the sender's ID that has been initially stripped away. More particularly, Scott's application software goes through a “for-loop” of all the clients in the client listing until a match is established. Once a match has been established, it assigns the incoming message to User A's queue, changes the font color of User A's name panel on Scott's main application window to a different color (such as yellow) to alert User B of message arrival, and breaks out of the “for-loop”.

Depending on the particular preference mode established at Scott's computer system an audible sound may be played to alert him that the message has arrived. That is, if Scott's application software has not enabled silent mode, then the program creates an instance of TMediaPlayer so that the selected .WAV file can be opened to play a selected sound. A look up is done for the appropriate .WAV file from Scott's preferences, and the sound is played to alert Scott that the message has arrived. Once the sound is finished, Scott's application software deletes the instant variable that was created for this purpose.

A function is then called by Scott's application software to decrypt the incoming message on Scott's terminal at step 126. Again, this function utilizes Scott's private key to decrypt the incoming message according to an RSA private key infrastructure. Here, it is preferred to utilized the 3-DES decryption algorithm, although other algorithms could certainly be employed. The various RSA functions are stored in a dynamic link library file on Scott's computer system. Once Scott has been alerted of the incoming message, he/she double-clicks on the corresponding client's panel associated with User A to retrieve the message. When Scott double-clicks on User A's panel, the font color is changed from yellow to blue and Scott's application software creates an instance of MyClients to locate the proper user ID. Once a match as been established, the program pulls the message from the queue and makes the receive dialog window 218 in FIG. 12 visible [rmsg.cpp], corresponding to step 128 in FIG. 4. If desired, a comparison can then take place to ensure that the received message is the same as that which was originally encrypted at User A's terminal at step 120. Thereafter, the secure message transfer methodology 100 may then be completed at 130.

When the received dialog window 218 is made visible, the client object that is stored in the global variable is cast to a local MyClients object. In FIG. 12, it may be seen that the receive dialog form contain four objects: a TMemo 220 used to display the message, two (2) TButtons 222 and 223, and a TBevel 224 that is used to outline the TMemo object 220. Scott then has two options. He can reply to the message or close the window. If Scott chooses to reply to the message by clicking on the “reply” button 222, his application program creates a new instance of a reply dialog window and scales the window to the proper size based on screen resolution. The program then makes a series of Windows API calls to make a window with rounded corners. When the preparation of the window is finished, the reply window 225 (FIG. 13) is made visible [reply.cpp], and the receive dialog window 220 prepares to close. During this preparation, if history has been enabled by Scott, then the received message is also written to the proper file and the receive dialog window 220 is closed. When the instance of the reply dialog window 225 is created, the client object stored in the global variable is cast to a local MyClient's object. The reply dialog form 225 contains four objects: a TMemo 226 used to input the reply message, a TBevel 227 used to outline the TMemo object, and two (2) TButtons 228 and 229 respectively, used to send the message or close the reply window 225 without sending the message. When a reply message has been typed by Scott and the “send” button 228 has been pressed, the first thing that happens is “/msg-mt” is pre-pended to the message and stored in a local stream variable. That variable is then passed along with a local MyClient's object variable that points User A's name to the encryption cipher. Based on User A's name, his/her public key is loaded and the reply message is encrypted. Upon completion of the encryption, the ciphertext is then returned to Scott's application. User A's ID is then pre-pended to the ciphertext message and this encrypted message is sent as a data stream to the server. Again, if Scott has “history” enabled as a preference, the reply message is also appended to a history file (.htf file) according to User A's name. Once this function has completed, the reply message dialog window 225 is closed and control is sent back to the main application at the point where it was made visible. Of course, if the “cancel” button 229 is pressed, then an appropriate function is called and the reply message dialog window 225 is closed and control is sent back to the point in the main application where the reply message dialog window 225 was made visible.

B. Encrypted File Transmission

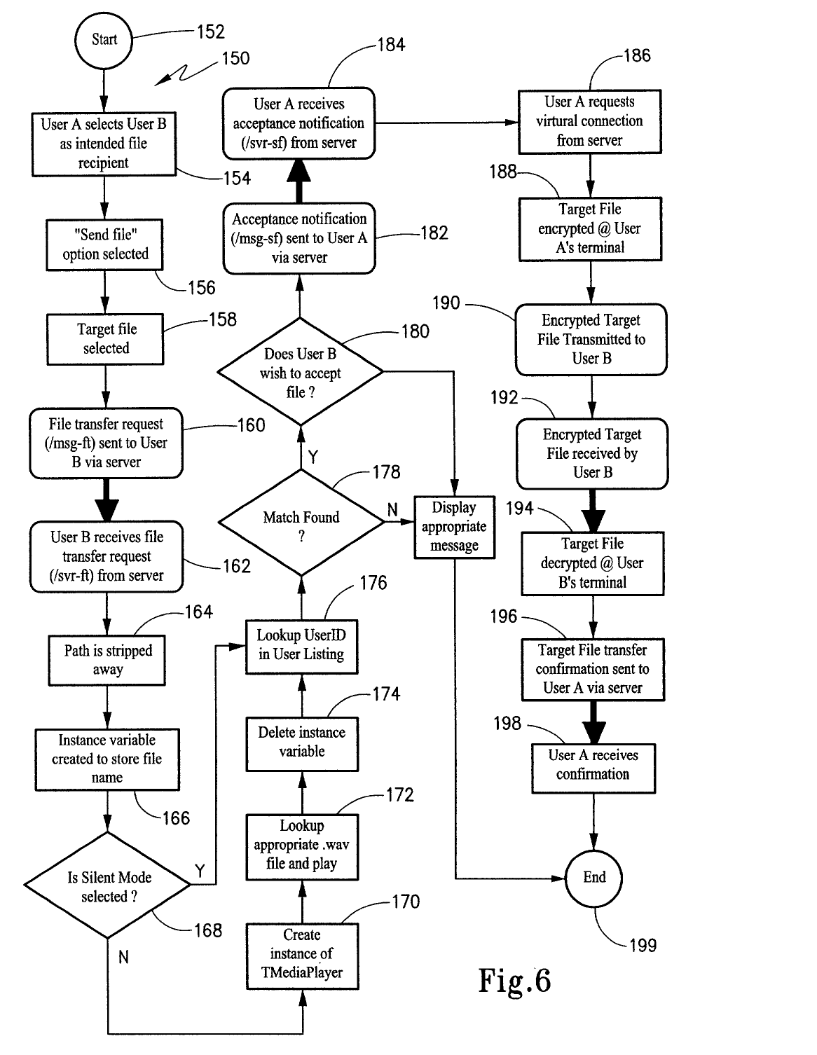

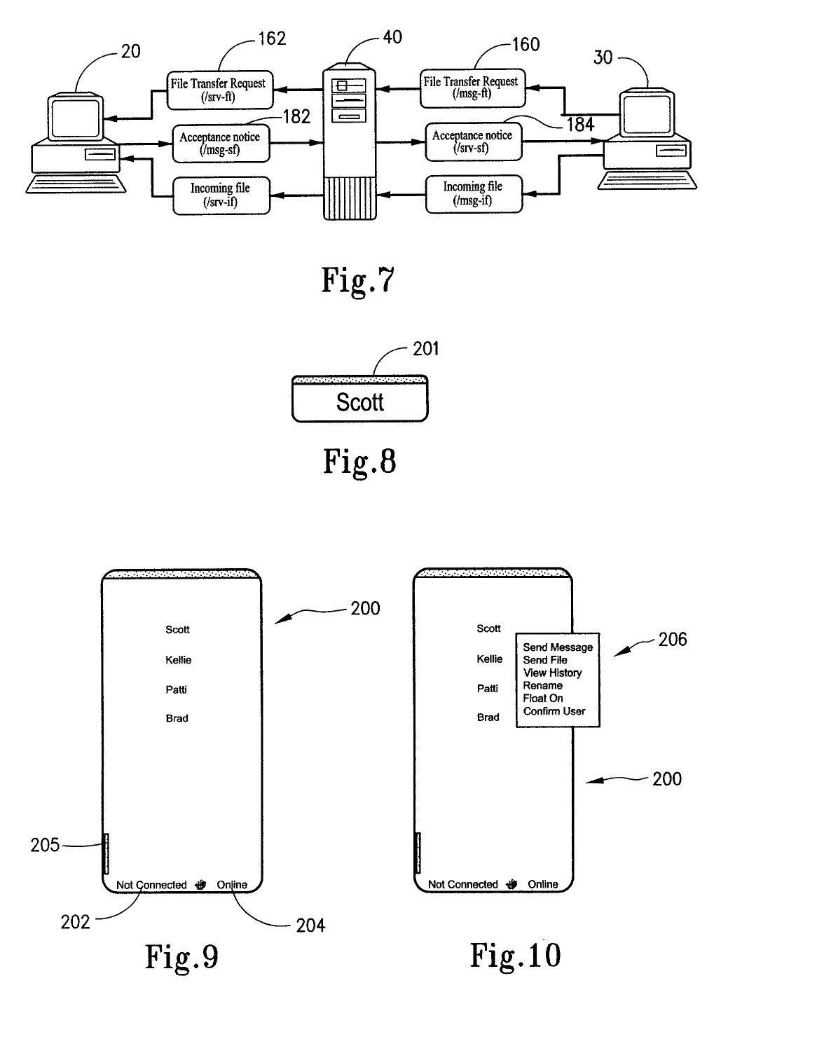

Reference is now made to FIGS. 6-10 and 14 to describe the process 150 by which User A's computer system 20 securely transmits data in the form of a file to User B's computer system 30, such as User Scott in FIG. 9. Following start at 152, User A selects Scott as the intended file recipient at 154, again preferably by selecting Scott from the listing on User A's main application window 200 of FIG. 9. Once Scott has been selected as the intended file recipient, User A at 156 now selects the “send file” option from the menu entries 206 in FIG. 10. The methodology 150, thus, now proceeds to select the target file at step 154.

An associated menu entry selection signal is received from the input device and a file designation window is prepared, such as window 230 shown in FIG. 14. More particularly, User A's software application creates a new instance of the file dialog window and scales the window to the proper size based on screen resolution. It then makes a series of Windows API calls to make a rounded window. When the preparation for the window is finished, the window 200 is made visible [sfile.cpp]. When the file designation window 230 is displayed, the client object that is stored as a global variable is cast to a local object.

The file designation window 230 contains five objects: a TEdit 232 for displaying the file name to be sent, three (3) TButtons, 233-235 respectively, and a TOpenDialog 236 that are used to display a standard windows open file dialog window. TButton 233 is used to open the file dialog window. When this dialog window is open, User A can select the file he/she wishes to send and the name for the selected file will appear in the TEdit box 232. User A can then send the file by activating TButton 234, or cancel the operation by activating TButton 235.

If User A clicks on the “Send” button a send button function is called by User A's software application. When this function is executed, the first thing that happens is that the 3-DES encryption function is called and the file name and location are passed to it. The encryption algorithm then opens the file and encrypts the contents using the 3-DES encryption method. The application then sends the file to be encrypted using Scott's public key. When the encryption is complete, the function renames the file in preparation for transmission. The encrypted (renamed) file is then returned to the Send button function.

A file transfer request is then sent to Scott via the network server at 160, with the message preferably having the following format “/msg-ft c:\\path_to_file\\file_name”. Correspondingly, a message appears letting User A know that Scott must first authorize transmission of the encrypted file. The file designation window 230 is then closed and control is returned to the main application. Once control is returned, User A's application software deletes the instance of the file designation window 230 and repaints the main application 200 in FIG. 9.

The server recognizes User A's file transfer request as being intended for Scott, and accordingly forwards the file transfer request to Scott in the format “/srv-ft c:\\path_to_file\\file_name”. Upon receipt of the forwarded file transfer request from the server, Scott's application software strips away the path at 164 and stores the file name in an appropriate instance variable at 166. Then, if a determination is made at 168 that silent mode has not been selected on Scott's computer system, an instance of TMediaPlayer is created at 170 and a look up is done at 172 for the appropriate .WAV file so that Scott's preferred sound selection can be played. The instance variable is then deleted at 174 and Scott's application software conducts a search in its client listing for the appropriate client ID (i.e. User A's identification). Of course, if silent mode has been enabled on Scott's computer system, then the methodology proceeds directly to the client ID look up at step 176 following inquiry 168.

If a match has not been found at 178, then the application causes an appropriate message to be displayed at 181 on Scott's computer system and the methodology terminates at 199. A similar message can be caused to be displayed on User A's computer terminal as desired. Assuming, however, that a match does exists at 178 then Scott's software application displays an appropriate message on the monitor, querying whether Scott wishes to accept a file from User A. Again, if Scott does not wish to accept a file, then an appropriate message can be displayed at 181 and the process terminated at 199. However, assuming Scott does wish to accept the file, an acceptance notification in the form “/msg-sf” is sent to User A's application via the network server at 182. The network server recognizes this as an acceptance notification being returned and forwards it in the form “/srv-sf” to User A's application which receives it at step 184. At this point, an instance variable is created by User A's application software to do a look up to confirm that the transmitted client ID corresponds to that associated with Scott stored on User A's computer system. Once a match has been found, a message in the form “/msg-if” is sent to the network server and forwarded to Scott in the form “/srv-if” to alert Scott's application that the file is forthcoming. User A's application also sends a message to the server at 186 requesting a virtual connection between the two users. A new instance variable of a file stream is created using the file name “file.tmp” for added security. A write buffer is then opened so that User A's application can send the contents of the file to User B along a virtual tunnel, again via the network server. Once the last byte has been received, this write buffer is closed and the file stream instantiated variable is deleted, as well as “file.tmp” on Scott's computer.

Upon receipt of the incoming data stream, which as stated above, includes the ciphertext corresponding to the target file as well as User A's routing identification, Scott's application software does a look up to confirm an ID match. Assuming a match is found, the target file is decrypted on Scott's terminal at 194 according to a selected decryption algorithm, such as 3-DES, which utilizes his private key. A file transfer confirmation is then sent from Scott to User A via the network server at 196 and User A receives confirmation at 198, at which point the process is completed at 199.

Having described the process by which both messages and files can be encrypted at a sending client's computer system and transmitted to a recipient client computer system via the network server in a simplified IM application having only two authorized users, the ordinarily skilled artisan should appreciate that these protocols can readily extend to encompass IM applications having a plurality of authorized users. Since each user can assign his/her own preferences regarding visibility status with respect to a selected one or more other authorized users, and since a given authorized user can either be logged-on to the network server, logged-off the network server or assume an away mode, it should be appreciated that status message from the network server may periodically be broadcast to one or all of the computer systems associated with the various users so that their resident databases are kept current.

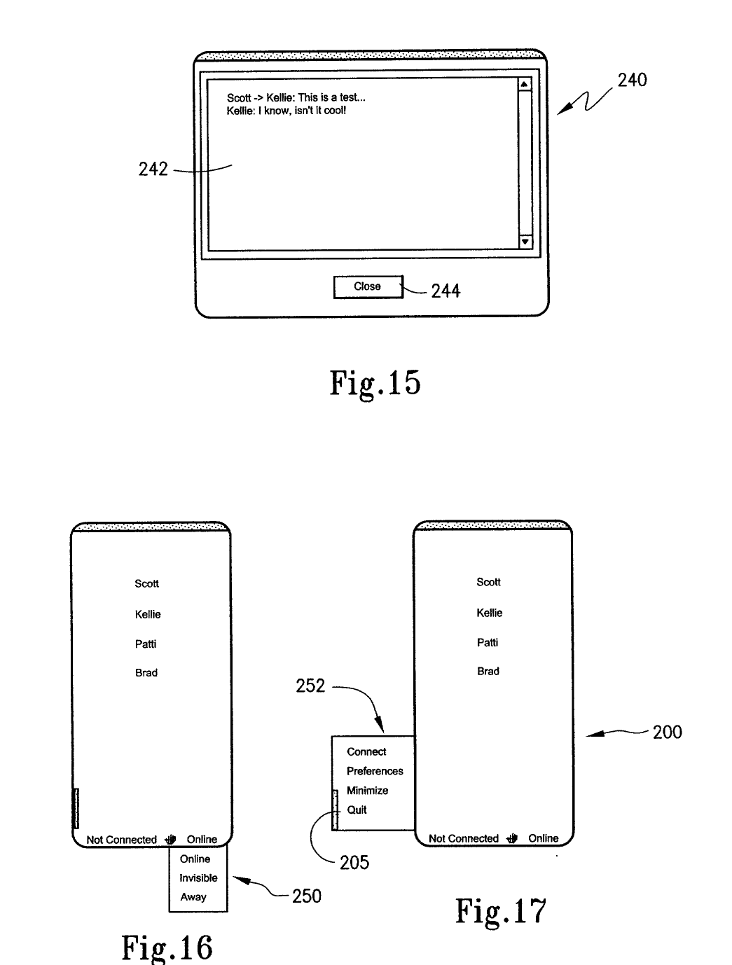

If the “view history” option is selected in FIG. 10, User A's application software creates a new instance of a history dialog window. The program then scales the window to the proper size based on screen resolution and makes a series of Windows API calls to make a rounded window. When the preparation for the window is complete, the history file is opened that corresponds to user “Scott” by retrieving his name from the MyClient's global variable. The history file is then opened and all of the contents are read into a local string buffer. When the preparation of the window is finished, the window 240 is made visible [histry.cpp] as shown in FIG. 15, and the contents of the string buffer are read into a TMemo and displayed The history dialog window contains two objects, a TMemo 242 and a TButton 244. When User A is finished perusing the history dialog window, the “Close” 244 button is pressed and control is restored to the main application.

If User A selects the “float” option in FIG. 10, User A's application software first determines whether there is a floating panel already associated with user “Scott” or if one should be created. This is indicated to User A by the caption on the pop up window which shows the first set of menu entries in FIG. 10, such that the caption on the pop up menu will either say “float off” or “float on”. If a floating panel does not already exist, then one is created for user Scott by spawning a container to hold the panel. The program then sets the name, size, font and color of the container and makes the appropriate Windows API calls to make the corners rounded. The program then creates a duplicate panel from the existing panel in the main application and places it in the floating container. The program then adds the name of the floating panel to the corresponding object variable in MyClients resulting in the panel and container being made visible. See FIG. 8. If a floating panel for user “Scott” already exists, then the menu will say “float off” when the right mouse button is depressed.

There are two points on the main application where User A can click and change options for the application. The first is a visibility button 203 which appears on the main application window 200 of FIG. 9. If User A clicks on visibility button 203 a drop down menu 250 (FIG. 16) appears for User A to change his/her visibility status [visibility.cpp]. When the visibility form is called, User A's application software makes a Windows API function call to animate the window. When the window has finished its animation, it is repainted to show the labels on drop down menu 250. There are three labels corresponding to the visibility modes: online, invisible and away. Each label is created at run-time, and has a roll over and click property associated with it. The roll over property changes the color of font as the mouse passes over it. The click properties are used to determine what action should be taken when User A clicks on one of the modes. If User A clicks on the “online” mode, it creates the message “/msg-li” and calls a broadcast message function and passes the message to that function. If User A clicks on the “invisible” mode, the program creates the message “/msg-iv” and passes this message to the broadcast message function. If “away” is clicked, the application creates the message “/msg-aw”, and passes this to the broadcast message function. When “away” is selected, the lock mode is then set and changed in User A's registry if User A has enabled the “lock when in away mode”. The effect of this selection is that User A's panel on the main application windows of other remote users will turn to red, or another appropriate color, to indicate that User A's computer system is unable to receive any messages. In any event, after any selection, the visibility window is closed and the visibility mode takes effect immediately.

The other option on the main application window 200 of FIG. 9 is for User A to click on a status bar 205 to bring up menu items 252 concerning an ability to change connection status, change preferences, minimize the main application window 200 or quit the application altogether. If the “preferences” option is selected, then another software code module [pref.cpp] is called to allow User A to change his/her preferences for the client computer system. The preferences dialog window 260 (see FIG. 18) contains four main objects: TPageControl, which contains five (5) TTabSheets, generally 270, each having their own objects, and two (2) TButtons 280 and 290.

The first tab sheet labeled “Start up” contains all the information to be executed when the application starts up. This first tab sheet (FIG. 18(a)) contains five objects on the panel: three (3) TCheckBoxes 263, one (1) TEdit 264 that contains the server's IP address, and one (1) TComboBox 265 that is used to select the default start up mode. One TCheckBox is used to enable the audio log on feature—that is, if User A does not wish to have to enter his/her user name and password when the application starts, he/she would check this box as shown in the figure. Another check box is used if User A wishes to lock the application when in away mode. If this is enabled, the application will prompt client A for a password every time the application is used. A third check box is used to enable SSL communication with the server.

The second tab sheet (FIG. 18(b)) gives User A the ability to change his/her password. It requires User A to input the current password and then enter the new password and verification thereof. When User A clicks on the change button 272, the application compares the value entered for the current password with the password that was loaded when the application was started. It then compares the two values for the password that User A wishes to change to. If they match, the password is sent to the Blowfish encryption cipher to be encrypted and stored in User A's registry. If the passwords do not match, User A is prompted with an error and asked to re-enter the passwords.

The third tab sheet (FIG. 18(c)) gives User A the ability to add or remove other users from his/her visibility list and enable/disable the visibility mode. All users by default are located in the visible list. However, if User A clicks the “right arrow” button 273, it takes the selected user from the visible list and moves him/her to the invisible list. The reverse holds true if the “left arrow” button 274 is pressed. The names for the visible and invisible lists are stored in the “visible.dat” and “invisible.dat” files, respectively, as discussed above.

The fourth tab sheet (FIG. 18(d)) gives User A the ability to set up his/her history preferences. Initially, history can either be enabled or disabled when the application is installed, and later changed depending on the status of check box 275. All history records are stored on User A's hard drive and encrypted using his/her private key.

The fifth and final tab sheet (FIG. 18(e)) is for setting audio sound preferences. It is here where User A has the option to turn sounds off, i.e. enable silent mode. If the corresponding check box 276 for silent mode is not checked then the audio alerts are heard. Selecting the panel from the list box 277 can set the associated sounds. The corresponding sound is displayed in the audio combo box, and it is here where User A can select a different sound to be associated with that action. When the “accept” button 278 is clicked, the first action performed is to ensure that there are no blank “TEdit” objects. Then, the corresponding variables are entered into either an “.ini” file or written to the registry. Users in the visible and invisible list are written to their respective “.dat” files. Of course, if the “cancel” button 279 is clicked, all changes are ignored and the preferences window is closed.

Accordingly, the present invention has been described with some degree of particularity directed to the exemplary embodiments thereof. It should be appreciated, though, that the present invention is defined by the following claims construed in light of the prior art so that modifications or changes may be made to the exemplary embodiments of the present invention without departing from the inventive concepts contained herein.

I claim:

1. A computerized instant messaging (IM) methodology for securely transmitting data from a sending client computer system to a recipient client computer system, each being logged on to a common network infrastructure and having an associated client application program installed thereon, and wherein said network infrastructure includes a network server having an associated server application program installed thereon, said computerized IM methodology comprising:
a. selecting plain text data for encrypted transmission from the sending client computer system to the recipient client computer system;
b. encrypting the plain text data at the sending client computer system according to a selected cryptographic algorithm which utilizes an encryption code, thereby to generate ciphertext data correlated to the plain text data;
c. sending the ciphertext data as part of a data stream along a secure connection from the sending client computer system to the recipient client computer system, whereby the ciphertext data is routed to the recipient client computer system via the network server without the network server archiving a record of the ciphertext data; and
d. decrypting the ciphertext data at the recipient client computer system according to a selected decryption algorithm which utilizes a decryption code, thereby to make the plain text data available for viewing on the recipient client computer system.

2. A computerized IM methodology according to claim 1 whereby transmission of the ciphertext data from the sending client computer system to the recipient client computer system only occurs if the sending client is identified on the recipient client computer system as an authorized message sender.

3. A computerized IM methodology according to claim 1 whereby the sending client computer system initially transmits a send data request to the recipient client computer system seeking permission from the recipient client computer system to transmit encrypted data, and whereby transmission of the ciphertext data to the recipient client computer system only occurs if the recipient client computer system transmits a reply to the sending client computer system granting permission to transmit the encrypted data.

4. A computerized IM methodology according to claim 3 whereby the plain text data that is selected is contained in a file stored on the sending client computer system.

5. A computerized IM methodology according to claim 1 whereby the recipient client is selected by the sending client computer system from a pool of users identified on the sending client computer system as being authorized to receive encrypted data transmissions from the sending client computer system.

6. A computerized IM methodology according to claim 1 wherein said encryption code and said decryption code are the same.

7. A computerized IM methodology according to claim 1 wherein said encryption code and said decryption code are different.

8. A computerized IM methodology according to claim 7 wherein said encryption code is a registered public key that is associated with the recipient client computer system and wherein said decryption code is a private key that is associated with said recipient client computer system, such that encryption key and said decryption key define a key pair.

9. A computerized IM methodology according to claim 1 whereby routing information associated with the recipient client computer system is prepended to the ciphertext data by the sending client computer system thereby to form said data stream, and whereby the server application program operates upon receipt of the data stream from the sending client computer system to compare said prepended routing information with stored routing information associated with the recipient client computer system, and is further operative to forward the data stream to the recipient client computer system only upon determining an existence of a first match therebetween.

10. A computerized IM methodology according to claim 9 whereby, upon existence of said first match, the server application program replaces the prepended routing information associated with the recipient client computer system with routing information associated with the sending client computer system prior to forwarding the ciphertext data to the recipient client computer system.

11. A computerized IM methodology according to claim 10 whereby, upon receipt of the data stream from the server, the recipient client computer system compares the prepended routing information associated with the sending client computer system with stored routing information associated with the sending client computer system to determine existence of a second match therebetween, and operates to decrypt to ciphertext data only upon determining an existence of said second match.

12. A computerized IM methodology according to claim 1 whereby decryption of the ciphertext data by the recipient client computer system occurs only upon a determination that the sending client computer system is one of a pool of users identified on the recipient client computer system as being authorized to transmit data to the recipient client computer system.

13. A computerized IM methodology according to claim 1 whereby the data stream is transmitted from the sending client computer system to the network server over a first secure socket layer (SSL) connection established therebetween, and whereby the data stream is forwarded from the network server to the recipient client computer system over a second SSL connection established therebetween.

14. A computer-readable medium adapted for use as a component of a client computer system that has a graphical user interface including a monitor and at least one data input device, wherein said client computer system is one of a plurality of client computer systems each residing as a respective node on a network infrastructure that includes a network server adapted to interface with each of said client computer systems to enable an exchange of messages therebetween as part of a client/server instant messaging (IM) application, and wherein each of said client computer systems is associated with an authorized user for the IM application, said computer-readable medium having computer executable instructions operative upon execution to perform a methodology comprising:
a. receiving from the network server first data representing those authorized users of the IM application who are connected to the network server, thereby to define a group of logged-on users;
b. controlling said monitor to display perceptible output of a first characteristic to identify said group of logged-on users;
c. receiving a logged-on user selection signal indicative of an identified logged-on user being selected by the data input device;
d. controlling said monitor after receipt of the logged-on user selection signal to display at least one of a message entry field and a file designation field;
e. receiving one of:
i. message entry signals from the data input device corresponding to entry of unencrypted data in the message entry field that is intended for encrypted transmission to the identified logged-on user; and
ii. file designation signals from the data input device representing location of a data file containing unencrypted data intended for encrypted transmission to the identified logged-on user;
f. receiving a send selection signal from the data input device;
g. in response to the send selection signal, encrypting the unencrypted data according to a selected cryptographic algorithm, thereby to generate ciphertext data; and
h. causing the ciphertext data and routing information associated with the identified logged-on user to be transmitted as a data stream, along a secure virtual connection via the network server, to a remote one of said client computer systems that is associated with the identified logged-on user.

15. A computer readable medium according to claim 14 for receiving from the network server second data representing those authorized users of the IM application who are disconnected from the network server, thereby to define a group of logged-out users.

16. A computer readable medium according to claim 15 for controlling said monitor to display perceptible output of a second characteristic different than the first characteristic to identify said group of logged-out users.

17. A computer readable medium according to claim 14 for receiving from the network server a first sub-set of data corresponding to a send data visible group of the logged-on users and a second sub-set of data corresponding to a send data invisible group of the logged-on users, wherein said send data visible group identifies those logged-on users within the group of logged-on users to whom the client computer system is permitted to send encrypted messages and the invisible group identifies those logged-on users within the group of logged-on users to whom the client computer system is prohibited from sending encrypted data.

18. A computer readable medium according to claim 17 for transmitting the data stream to the network server only upon determining that the identified logged-on user is a member of the send data visible group of logged-on users.

19. A computer readable medium according to claim 18 for receiving from the input device a third sub-set of data corresponding to a receive data visible group of the logged-on users and a fourth sub-set of data corresponding to a receive data invisible group of the logged-on users, wherein said receive data visible group identifies those logged-on users within the group of logged-on users who are permitted to send encrypted messages to the client computer system and the invisible group identifies those logged-on users within the group of logged-on users who are prohibited from sending encrypted messages to the client computer system.

20. A computer readable medium according to claim 19 for transmitting said third sub-set of data and said fourth sub-set of data to the network server.

21. A computer readable medium according to claim 19 for monitoring a communications interface to detect incoming data streams from the network server containing current status information relating to said group of logged-on users, said group of logged-off users, said send data visible group of logged-on users and said send data invisible group of logged-on users, and for storing said status data with the client computer system in respective memory locations.

22. A computer readable medium according to claim 14 for monitoring a communications interface to detect incoming data streams from the network server each corresponding to an encrypted message originating from an associated remote one of the client computer systems, and each including associated ciphertext data and a prepended routing identification associated with the remote client computer system.

23. A computer readable medium according to claim 22 for determining, with respect to each detected one of said data streams, an existence of a match between said prepended routing information and stored routing information that is associated with the remote client computer system.

24. A computer readable medium according to claim 23 for decrypting the received ciphertext data according to a selected decryption algorithm only upon determining existence of said match.

25. A computer readable medium according to claim 24 for utilizing a private decryption key associated with the client computer system to decrypt the received ciphertext data.

26. A computer readable medium according to claim 14 for utilizing a public encryption key associated the identified logged-on user to encrypt said unencrypted data.

27. A computer-readable medium adapted for use as a component of a client computer system that is one of a plurality of client computer systems each residing as a respective node on a network infrastructure that includes a network server adapted to interface with each of said client computer systems to enable an exchange of messages therebetween as part of a client/server messaging application, the computer-readable medium having stored thereon a data structure comprising:
a. a plurality of record entries each associated with a respective authorized user of the messaging application, each of said record entries comprising:
i. a first field containing data representing a connection status for the respective authorized user to indicate that the respective authorized user is either connected to or disconnected from the network server;
ii. a second field containing data representing a visibility status for the respective authorized user to indicate that whether the respective authorized user is permitted to send messages to the client computer system; and
iii. a resultant field containing data representing a set of message exchange capabilities between the client computer system and the respective authorized user and derived as a correlation of at least the first and second data fields.

28. A computer readable medium according to claim 27 wherein each of said record entries in said data structure includes a third field containing data representing an encryption key for the respective authorized user, and wherein said resultant field is derived as a correlation of the first, second and third fields.

29. A computer readable medium according to claim 27 wherein each of said record entries in said data structure includes a fourth field containing data representing a routing identification number for the respective authorized user.

30. In a computer system having a graphical user interface including a monitor and at least one input device, wherein said computer system is one of a plurality of client computer systems each residing as a respective node on a network infrastructure that includes a network server capable of enabling an exchange of messages therebetween as part of a client/server messaging application, and wherein each of said client computer systems is associated with an authorized user for the IM application, a method of providing and selecting from menus on the display, the method comprising:
a. retrieving from a storage device a global set of entries each representing a selected one of said authorized users;
b. retrieving from said global set of entries a first group of entries for a first listing, each of said first group of entries representing a selected one of said authorized users who is currently logged-on to the network server and who is visible to the client computer system;
c. displaying the first group of entries on the monitor as a first group perceptible output having a first characteristic, thereby to indicate users who are available for receiving encrypted data transmissions from the client computer system;
d. receiving a first group selection signal indicative of the input device identifying an authorized user by designating a selected entry from the first group;
e. in response to the first group selection signal, retrieving from the storage device an associated first set of menu entries for the identified user, each representing an available action with respect to the identified user;
f. displaying the associated first set of menu entries on the monitor; and
g. receiving a menu entry selection signal from the input device corresponding to the input device designating a selected entry from the associated first set of menu entries.

31. A method according to claim 30 wherein one said available action for the identified user corresponds to a send message option, and comprising displaying a message entry window on the monitor when the menu entry selection signal corresponds to the input device designating the send message option.

32. A method according to claim 30 wherein another said available action for the identified user corresponds to a send file option, and comprising displaying a file designation window on the monitor when the menu entry selection signal corresponds to the input device designating the send file option.

33. A method according to claim 30 wherein one said available action for the identified user corresponds to a send file option, and comprising displaying a file designation window on the monitor when the menu entry selection signal corresponds to the input device designating the send file option.

34. A method according to claim 30 wherein the first set of menu entries for the selected entry includes available actions corresponding to an ability to send a message to the identified user, send a file to the identified user, and view prior correspondences associated with the identified user.

35. A method according to claim 30 comprising retrieving from said global set of entries a second group of entries for a second listing, each of said second group of entries representing a selected one of said authorized users who is logged-off of the network server, and displaying the second group of entries on the monitor as a second perceptible output having a second characteristic different than the first characteristic, thereby to indicate users who are unavailable for receiving encrypted data transmissions from the client computer system.

36. A method according to claim 35 wherein said first perceptible output is of a first color and said second perceptible output is of a second color different from the first color, and comprising arranging said first and second groups of entries on the monitor as a vertical listing of names each corresponding to an associated one of said authorized users.

37. A method according to claim 36 comprising displaying said first and second group of entries on the monitor against a background which resembles a front panel of a computer case.

38. A method according to claim 30 comprising arranging said first group of entries on the monitor as a vertical listing of names each of a common color and each corresponding to an associated one of said authorized users, and against a background which resembles a front panel of a computer case.

39. A method according to claim 30 comprising, in response to the first group selection signal, retrieving from the storage device an associated second set of menu entries for the selected entry, each representing at least one unavailable action with respect the identified user, and displaying the associated second set of menu entries on the monitor.

40. A method according to claim 30 comprising detecting presence of an incoming message, ascertaining whether the incoming message originated from one of the authorized users represented by said global set of entries, and changing the perceptible output on the monitor upon a determination that the incoming message originated from one of the authorized users thereby to provide an alert indicative of the incoming message.

41. A method according to claim 28 comprising performing a search of said storage device to locate data corresponding to a public key associated with the identified user and, if the public key cannot be located, displaying within the associated first set of menu entries an available action corresponding to an ability to obtain the public key associated with the identified user.

42. A method according to claim 30 comprising retrieving from said global set of entries a second set of entries for a second listing, each of said second set of entries representing a selected one of said authorized users who is currently logged-on the network server and who is invisible to the client computer system.

43. A client computer system for use as a component in a client/server messaging application that is implemented over a network infrastructure, wherein said network infrastructure includes a plurality of client computer systems, each residing as a respective node on the network infrastructure, and an associated network server adapted to interface with each of said client computer systems to enable an exchange of messages therebetween as part of a client/server instant messaging (IM) system, said client computer system comprising:
a. a storage device;
b. at least one input device;
c. a monitor;
d. a network interface for enabling transmission of data to and from the network server; and
e. a processor programmed to:
i. retrieve from the network server first data representing those authorized users of the IM application who are connected to the network server, thereby to define a group of logged-on users;
ii. control said monitor to display perceptible output of a first characteristic to identify said group of logged-on users;
iii. receive a logged-on user selection signal indicative of an identified logged-on user being selected by the data input device;
iv. control said monitor after receipt of the logged-on user selection signal to display at least one of a message entry field and a file designation field;
v. receive one of:
1. message entry signals from the input device corresponding to entry of unencrypted data in the message entry field that is intended for encrypted transmission to the identified logged-on user; and
2. file designation signals from the input device which represent the location of a data file containing unencrypted data intended for encrypted transmission to the identified logged-on user;
vi. receive a send selection signal from the input device;
vii. respond to the send selection signal by encrypting the unencrypted data according to a selected cryptographic algorithm, thereby to generate ciphertext data; and
viii. cause the ciphertext data and routing information associated with the identified logged-on user to be transmitted as a data stream, along a secure connection via the network server, to a remote one of said client computer systems that is associated with the identified logged-on user.

44. A client computer system according to claim 43 wherein said processor is programmed to receive from the network server second data representing those authorized users of the IM application who are disconnected from the network server, thereby to define a group of logged-out users, and to control said monitor to display perceptible output of a second characteristic identifying said group of logged-out users.

45. A client computer system according to claim 43 wherein said processor is programmed to receive from the network server a first sub-set of data corresponding to a send data visible group of the logged-on users and a second sub-set of data corresponding to a send data invisible group of the logged-on users, wherein said send data visible group identifies those logged-on users within the group of logged-on users to whom the client computer system is permitted to send encrypted messages and the invisible group identifies those logged-on users within the group of logged-in users to whom the client computer system is prohibited from sending encrypted data.

46. A client computer system according to claim 43 wherein said processor is programmed to transmit the data stream to the network server only upon determining that the identified logged-on user is a member of the send data visible group of logged-on users.

47. A client computer system according to claim 45 wherein said processor is programmed to receive from the input device a third sub-set of data corresponding to a receive data visible group of the logged-on users and a fourth sub-set of data corresponding to a receive data invisible group of the logged-on users, wherein said receive data visible group identifies those logged-on users within the group of logged-on users who are permitted to send encrypted messages to the client computer system and the invisible group identifies those logged-on users within the group of logged-on users who are prohibited from sending encrypted messages to the client computer system.

48. A client computer system according to claim 47 wherein said processor is programmed to transmit said third sub-set of data and said fourth sub-set of data to the network server.

49. A client computer system according to claim 47 wherein said processor is programmed to monitor said network interface to detect incoming data streams from the network server containing current status information relating to said group of logged-on users, said group of logged-off users, said send data visible group of logged-on users and said send data invisible group of logged-on users, and for storing said status data with the client computer system in respective memory locations.

50. A client computer system according to claim 49 wherein said processor is programmed to monitor said network interface to detect incoming data streams from the network server each corresponding to an encrypted message originating from an associated remote one of the client computer systems, and each including associated ciphertext data and a prepended routing identification associated with the remote client computer system.

51. A client computer system according to claim 50 wherein said processor is programmed to determine, with respect to each detected one of said data streams, an existence of a match between said prepended routing information and stored routing information that is associated with the remote client computer system and to decrypt the received ciphertext data according to a selected decryption algorithm only upon determining existence of said match.

52. A client computer system according to claim 51 wherein said processor is programmed to utilize a private decryption key associated with the client computer system to decrypt the received ciphertext data and to utilize a public encryption key associated with the identified logged-on user to encrypt said unencrypted data.

53. A client computer system according to claim 43 wherein said processor is programmed to utilize a public encryption key associated the identified logged-on user to encrypt said unencrypted data.
